(19) United States
(12) Patent Application Publication
(10) Pub. No.: US 2026/0343153 A1
(43) Pub. Date: Oct. 29, 2026

(54) INFORMATION PROCESSING APPARATUS, INFORMATION PROCESSING SYSTEM, AND INFORMATION PROCESSING METHOD

(71) Applicant: SONY GROUP CORPORATION, TOKYO (JP)

(72) Inventors: OSAMU NAKAMURA, TOKYO (JP); KYOSUKE MATSUMOTO, TOKYO (JP); SHINPEI TSUCHIYA, TOKYO (JP)

(21) Appl. No.: 19/118,351

(22) PCT Filed: Sep. 29, 2023
(86) PCT No.: PCT/JP2023/035601

§ 371 Date: Apr. 3, 2025

(30) Foreign Application Priority Data
Oct. 11, 2022 (JP) 2022-163411

(51) Int. Cl. H04R 25/00

(52) U.S. Cl. CPC H04R 25/30; H04R 2225/39

(57) ABSTRACT

Provided is an information processing apparatus capable of being at least partially attached to an ear canal of a user, including: an output unit that outputs a measurement sound for detecting an abnormality of the information processing apparatus; a first sound collection unit that collects the measurement sound; and an abnormality detection unit that detects the abnormality based on an acoustic signal collected by the first sound collection unit.

### FIELD

The present disclosure relates to an information processing apparatus, an information processing system, and an information processing method.

### BACKGROUND

Hearing aids are widely used as devices for aiding the hearing of a user. For example, a hearing aid includes a microphone and a receiver. At least a part thereof is attached to an ear canal of the user.

### CITATION LIST

### Patent Literature

Patent Literature 1: JP 2017-536782 A

### SUMMARY

### Technical Problem

The above-described hearing aid is used to aid the hearing of the user. When an abnormality occurs, the hearing aid is required to quickly detect the occurrence of the abnormality and notify the user.

Thus, the present disclosure proposes an information processing apparatus, an information processing system, and an information processing method capable of easily and accurately

### Solution to Problem

According to the present disclosure, there is provided an information processing apparatus capable of being at least partially attached to an ear canal of a user. The information processing apparatus includes: an output unit that outputs a measurement sound for detecting an abnormality of the information processing apparatus; a first sound collection unit that collects the measurement sound; and an abnormality detection unit that detects the abnormality based on an acoustic signal collected by the first sound collection unit.

Furthermore, according to the present disclosure, there is provided an information processing system including: an information processing apparatus capable of being at least partially attached to an ear canal of a user; and a charger of the information processing apparatus. In the information processing system, the information processing apparatus includes: an output unit that outputs a measurement sound for detecting an abnormality of the information processing apparatus; a first sound collection unit that collects the measurement sound; and an abnormality detection unit that detects the abnormality based on an acoustic signal collected by the first sound collection unit.

Furthermore, according to the present disclosure, there is provided an information processing method of detecting an abnormality of an information processing apparatus capable of being at least partially attached to an ear canal of a user. The information processing method includes: outputting a measurement sound for detecting an abnormality of the information processing apparatus; collecting the measurement sound; and detecting the abnormality based on an acoustic signal that has been collected, by the information processing apparatus,

### BRIEF DESCRIPTION OF DRAWINGS

FIG. 1 illustrates a schematic configuration of a hearing aid system 1 according to embodiments of the present disclosure.

FIG. 2 is a functional block diagram of a hearing aid 2 and a charger 3 according to the embodiments of the present disclosure.

FIG. 3 is a block diagram of an information processing terminal 40 according to the embodiments of the present disclosure.

FIG. 4 illustrates a configuration example of an ear hanging type hearing aid 100 according to the embodiments of the present disclosure.

FIG. 5 is a cross-sectional view illustrating a state in which a receiver 101 of the ear hanging type hearing aid 100 according to the embodiments of the present disclosure is inserted into an ear canal of a user.

FIG. 6 illustrates a configuration example of an ear hole type hearing aid 500 according to the embodiments of the present disclosure.

FIG. 7 is a cross-sectional view illustrating a state in which the ear hole type hearing aid 500 according to the embodiments of the present disclosure is inserted into the ear canal of the user.

FIG. 8 is an explanatory diagram illustrating an example of application to the ear hanging type hearing aid 100 according to a first embodiment of the present disclosure.

FIG. 9 is an explanatory diagram illustrating an example of application to the ear hole type hearing aid 500 according to the first embodiment of the present disclosure.

FIG. 10 is an explanatory diagram illustrating an example of the characteristics of a measurement sound collected in the first embodiment of the present disclosure.

FIG. 11 is a functional block diagram of the hearing aid 100 according to the first embodiment of the present disclosure.

FIG. 12 is a functional block diagram of an abnormality detection unit 133 according to the first embodiment of the present disclosure.

FIG. 13 is a flowchart of an information processing method according to the first embodiment of the present disclosure.

FIG. 14 is an explanatory diagram illustrating an example of application to the ear hanging type hearing aid 100 according to a second embodiment of the present disclosure.

FIG. 15 is an explanatory diagram illustrating an example of application to the ear hole type hearing aid 500 according to the second embodiment of the present disclosure.

FIG. 16 is an explanatory diagram illustrating a configuration of a charger 800 that stores the hearing aid 100 in the second embodiment of the present disclosure.

FIG. 17 is an explanatory diagram (part 1) illustrating an example of application to the ear hanging type hearing aid 100 according to a third embodiment of the present disclosure.

FIG. 18 is an explanatory diagram (part 2) illustrating an example of application to the ear hanging type hearing aid 100 according to the third embodiment of the present disclosure.

FIG. 19 is a functional block diagram of a trigger detection function of the charger 800 according to a fourth embodiment of the present disclosure.

FIG. 20 is a flowchart of an information processing method according to the fourth embodiment of the present disclosure.

FIG. 21 is an explanatory diagram illustrating a notification example according to the fourth embodiment of the present disclosure.

FIG. 22 is an explanatory diagram (part 1) illustrating a notification example according to a fifth embodiment of the present disclosure.

FIG. 23 is an explanatory diagram (part 2) illustrating a notification example according to the fifth embodiment of the present disclosure.

FIG. 24 is an explanatory diagram illustrating a notification setting screen according to a sixth embodiment of the present disclosure.

FIG. 25 is an explanatory diagram illustrating an example of application to the ear hole type hearing aid 500 according to a seventh embodiment of the present disclosure.

FIG. 26 is an explanatory diagram illustrating a variation of application to the ear hole type hearing aid 500 according to the seventh embodiment of the present disclosure.

FIG. 27 is a flowchart of an information processing method according to the seventh embodiment of the present disclosure.

FIG. 28 is an explanatory diagram illustrating an example of application to the ear hole type hearing aid 500 according to an eighth embodiment of the present disclosure.

FIG. 29 is an explanatory diagram illustrating an example of the characteristics of a measurement sound collected in the eighth embodiment of the present disclosure.

FIG. 30 is an explanatory diagram illustrating a variation of application to the ear hole type hearing aid 500 according to the eighth embodiment of the present disclosure.

FIG. 31 is a functional block diagram of the hearing aid 500 according to the eighth embodiment of the present disclosure.

FIG. 32 is a flowchart of an information processing method according to the eighth embodiment of the present disclosure.

FIG. 33 is an explanatory diagram illustrating an example of application to the ear hole type hearing aid 500 according to a ninth embodiment of the present disclosure.

FIG. 34 is a functional block diagram of a device on the side of a third microphone 906 according to the ninth embodiment of the present disclosure.

FIG. 35 is an explanatory diagram illustrating an example of application to the ear hole type hearing aid 500 according to a 10th embodiment of the present disclosure.

FIG. 36 is an explanatory diagram illustrating an example of the characteristics of a measurement sound collected in the 10th embodiment of the present disclosure.

FIG. 37 is a flowchart of an information processing method according to the 10th embodiment of the present disclosure.

FIG. 38 is an explanatory diagram illustrating an example of the characteristics of a measurement sound collected in an 11th embodiment of the present disclosure.

FIG. 39 is a flowchart of an information processing method according to the 11th embodiment of the present disclosure.

FIG. 40 is an explanatory diagram illustrating an example of application to the ear hole type hearing aid 500 according to a 12th embodiment of the present disclosure.

FIG. 41 is a functional block diagram of a device on the side of a camera 527 according to the 12th embodiment of the present disclosure.

FIG. 42 illustrates a schematic configuration of the hearing aid system 1 according to the 13th embodiment of the present disclosure.

FIG. 43 illustrates a schematic configuration of a hearing aid system 1a according to a 14th embodiment of the present disclosure (part 1).

FIG. 44 illustrates a schematic configuration of the hearing aid system 1a according to the 14th embodiment of the present disclosure (part 2).

FIG. 45 is a block diagram of a server 90 according to the 14th embodiment of the present disclosure.

FIG. 46 illustrates an example of data utilization.

FIG. 47 illustrates an example of data.

FIG. 48 illustrates an example of cooperation with another device.

FIG. 49 illustrates an example of application transition.

### DESCRIPTION OF EMBODIMENTS

Preferred embodiments of the present disclosure will be described in detail below with reference to the accompanying drawings. Note that, in the present specification and the drawings, components having substantially the same functional configuration are denoted by the same reference signs, and redundant description thereof will be omitted. Furthermore, in the present specification and the drawings, a plurality of components having substantially the same or similar functional configuration may be distinguished by attaching different alphabets after the same reference signs. Note, however, that, when it is unnecessary to particularly distinguish a plurality of components having substantially the same or similar functional configuration, only the same reference signs are attached.

Note that the description will be given in the following order.
1. Outline of Hearing Aid System
2. BACKGROUND
3. First Embodiment
4. Second Embodiment
5. Third Embodiment
6. Fourth Embodiment
7. Fifth Embodiment
8. Sixth Embodiment
9. Seventh Embodiment
10. Eighth Embodiment
11. Ninth Embodiment
12. 10th Embodiment
13. 11th Embodiment
14. 12th Embodiment
15. 13th Embodiment
16. 14th Embodiment
17. Conclusion
18. Example of Data Utilization
19. Example of Cooperation with Another Device
20. Example of Application Transition
21. Supplements

### 1. Outline of Hearing Aid System

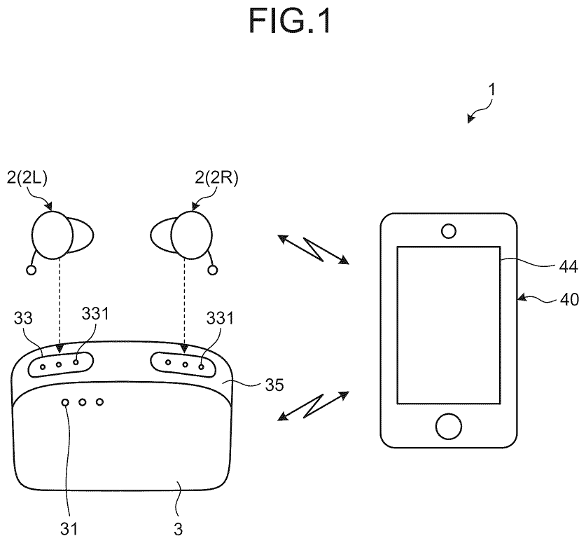

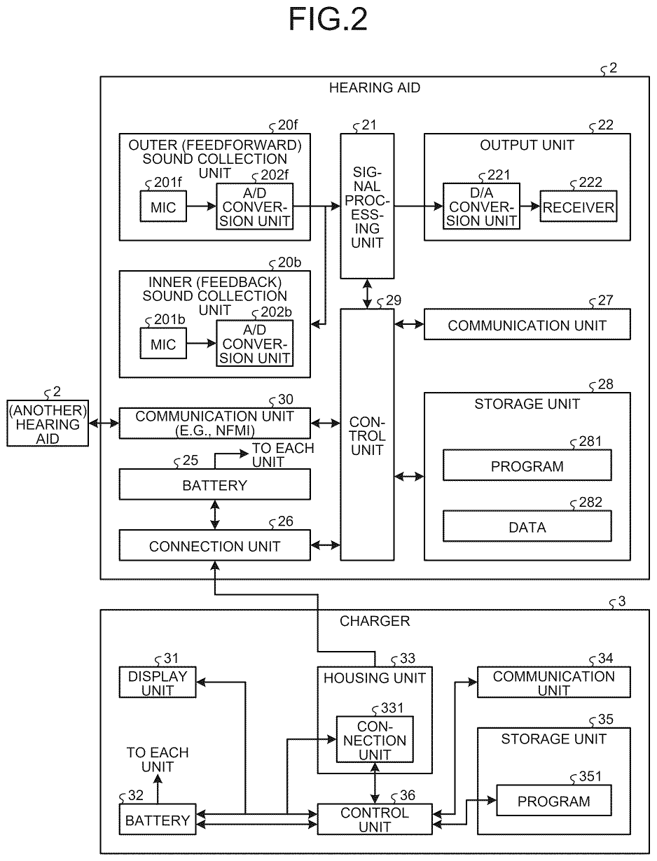

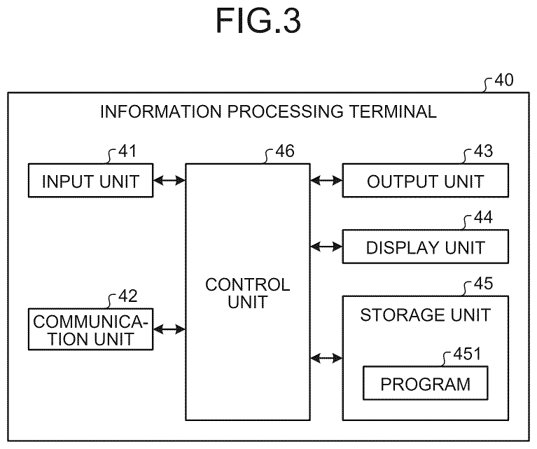

First, a hearing aid system 1 according to embodiments of the present disclosure will be outlined with reference to FIGS. 1 to 3. FIG. 1 illustrates a schematic configuration of the hearing aid system 1 according to the embodiments of the present disclosure. FIG. 2 is a functional block diagram of hearing aids 2 and a charger 3 according to the embodiments of the present disclosure. FIG. 3 is a block diagram of an information processing terminal 40 according to the embodiments of the present disclosure.

As illustrated in FIG. 1, the hearing aid system 1 according to the embodiments of the present disclosure includes a pair of right and left hearing aids 2, the charger 3 (charging case), and the information processing terminal 40. The charger 3 houses the hearing aids 2, and charges the hearing aids 2. The information processing terminal 40 includes a smartphone, and can communicate with at least one of the hearing aids 2 and the charger 3. Each device included in the hearing aid system 1 according to the embodiments of the present disclosure will be sequentially described below.

Note that, although the hearing aids 2 will be described below as being configured as a pair for both ears, the embodiments of the present disclosure are not limited thereto. A single-ear type hearing aid to be attached to one of both ears may be used.

First, a functional configuration of a hearing aid 2 will be described. In the embodiments of the present disclosure, at least a part of the hearing aid 2 can be attached to a part of an ear canal of a user (details will be described later). Then, as illustrated in FIG. 2, the hearing aid 2 mainly includes sound collection units 20 (20b and 20f), a signal processing unit 21, an output unit 22, a battery 25, a connection unit 26, communication units 27 and 30, a storage unit 28, and a control unit 29.

The sound collection units 20 include an outer (feedforward) sound collection unit 20f and an inner (feedback) sound collection unit 20b. The outer sound collection unit 20f collects sounds in an outer region of the ear canal. The inner sound collection unit 20b collects sounds in an inner region of the ear canal. Note that the hearing aid 2 according to the embodiments of the present disclosure is only required to be provided with at least the outer sound collection unit 20f that collects sounds in the outer region of the ear canal. Each of the sound collection units 20 includes a microphone (hereinafter, also referred to as mic) 201 and an analog/digital (A/D) conversion unit 202. The mic 201 collects a sound, generates an analog voice signal (acoustic signal), and outputs the analog voice signal to the A/D conversion unit 202. The A/D conversion unit 202 performs digital conversion processing on the analog voice signal input from the mic 201, and outputs the digitized voice signal to the signal processing unit 21.

The signal processing unit 21 performs predetermined signal processing on the digital voice signal input from the sound collection units 20, and outputs the digital voice signal to the output unit 22 under the control of the control unit 29 to be described later. Here, the predetermined signal processing includes filtering processing, amplification processing, noise reduction processing, and howling cancellation processing. In the filtering processing, voice signals are separated for each predetermined frequency band. In the amplification processing, amplification is performed in a predetermined amplification amount for each predetermined frequency band at which the filtering processing has been performed. The signal processing unit 21 can include, for example, a memory and a processor having hardware such as a digital signal processor (DSP).

The output unit 22 includes a digital/analog (D/A) conversion unit 221 and a receiver 222. The D/A conversion unit 221 performs analog conversion processing on the digital voice signal input from the signal processing unit 21, and outputs the digital voice signal to the receiver 222. The receiver 222 outputs output sound (voice) corresponding to the analog voice signal input from the D/A conversion unit 221. The receiver 222 can include, for example, a speaker.

The battery 25 supplies power to each unit constituting the hearing aid 2. The battery 25 can include, for example, a rechargeable secondary battery such as a lithium-ion battery. Moreover, the battery 25 can be charged by power supplied from the charger 3 via the connection unit 26.

For example, when the hearing aid 2 is housed in the charger 3, the connection unit 26 is connected to a connection unit of the charger 3. The connection unit 26 can receive power and various types of information from the charger 3, and output various types of information to the charger 3. The connection unit 26 can include, for example, one or a plurality of pins.

The communication unit 27 can communicate with the charger 3 or the information processing terminal 40 in conformity with a predetermined communication standard via a communication network under the control of the control unit 29. Here, for example, Wi-Fi (registered trademark) and Bluetooth (registered trademark) are assumed as the predetermined communication standard. The communication unit 27 can include, for example, a communication module. Moreover, the communication unit 30 can communicate with the other hearing aid 2 by short-range communication and the like such as near field magnetic induction (NFMI) under the control of the control unit 29.

The storage unit 28 stores various types of information on the hearing aid 2. The storage unit 28 can include, for example, a random access memory (RAM), a read only memory (ROM), and a memory card. The storage unit 28 can store a program 281 to be executed by the hearing aid 2 and various types of data 282 to be used in the hearing aid 2. Examples of the data 282 can include the age of the user, the presence or absence of an experience of use of the hearing aid 2 of the user, and the gender of the user. Moreover, examples of the data can include a use time when the user has used the hearing aid 2. The use time is clocked by a clocking unit (not illustrated). Furthermore, the clocking unit is provided inside the hearing aid 2. The clocking unit can clock date and time, and output the clocking result to the control unit 29 and the like. The clocking unit can include, for example, a timing generator and a timer having a clocking function.

The control unit 29 controls each unit constituting the hearing aid 2. The control unit 29 can include, for example, a memory and a processor having hardware such as a central processing unit (CPU) and a digital signal processor (DSP). The control unit 29 reads and executes the stored program 281 in a work area of the memory, and controls each component and the like through execution of the program performed by the processor.

Furthermore, although not illustrated in FIG. 2, the hearing aid 2 may include an operation unit. The operation unit can receive input of an activation signal (trigger signal) for activating the hearing aid 2, and output the received activation signal to the control unit 29. The operation unit can include, for example, a push switch, a button, and a touch panel.

Furthermore, the hearing aid 2 may be mounted with a biological information sensor (not illustrated), which is a non-invasive sensor device capable of acquiring various types of biological information (sensing data) on the user. Examples of the biological information sensor include a blood flow sensor that detects pulse, heart rate, blood flow, blood oxygen, and the like of the user.

Next, a functional configuration of the charger 3 will be described. As illustrated in FIG. 2, the charger 3 mainly includes a display unit 31, a battery 32, a housing unit 33, a communication unit 34, a storage unit 35, and a control unit 36.

The display unit 31 displays various states related to the hearing aid 2 under the control of the control unit 36. For example, the display unit 31 can display information indicating that the hearing aid 2 is being charged and information indicating that various types of information are being received from the information processing terminal 40. The display unit 31 can include, for example, a light emitting diode (LED).

The battery 32 supplies power to each unit constituting the hearing aid 2 and the charger 3 housed in the housing unit 33 via a connection unit 331 provided in the housing unit 33. The battery 32 can include, for example, a secondary battery such as a lithium-ion battery.

When two channels of right and left hearing aids 2 are used, the housing unit 33 separately houses the hearing aids 2. Note that a single-ear type hearing aid 2 may be used. Furthermore, the connection unit 331 is provided in the housing unit 33. The connection unit 331 can be connected to the connection unit 26 of the hearing aid 2. When the hearing aid 2 is housed in the housing unit 33, the connection unit 331 is connected to the connection unit 26 of the hearing aid 2, transmits power from the battery 32 and various types of information from the control unit 36, receives various types of information from the hearing aid 2, and outputs the information to the control unit 36. The connection unit 331 can include, for example, one or a plurality of pins.

The communication unit 34 communicates with the information processing terminal 40 in conformity with a predetermined communication standard via a communication network under the control of the control unit 36. The communication unit 34 can include, for example, a communication module.

The storage unit 35 stores various programs 351 to be executed by the charger 3. The storage unit 35 can include, for example, a RAM, a ROM, a flash memory, and a memory card.

The control unit 36 controls each unit constituting the charger 3. For example, when the hearing aid 2 is housed in the housing unit 33, the control unit 36 supplies power from the battery 32 via the connection unit 331. The control unit 36 can include, for example, a memory and a processor having hardware such as a CPU and a DSP. The control unit 36 reads and executes a program 351 in a work area of the memory, and controls each component and the like through execution of the program performed by the processor.

Next, a functional configuration of the information processing terminal 40 will be described. As illustrated in FIG. 3, the information processing terminal 40 mainly includes an input unit 41, a communication unit 42, an output unit 43, a display unit 44, a storage unit 45, and a control unit 46.

The input unit 41 receives inputs of various operations from the user, and outputs signals in accordance with the received operations to the control unit 46. The input unit 41 can include, for example, a switch and a touch panel.

The communication unit 42 communicates with the charger 3 or the hearing aid 2 via the communication network under the control of the control unit 46. The communication unit 42 can include, for example, a communication module.

The output unit 43 outputs a volume at a predetermined sound pressure level for each predetermined frequency band under the control of the control unit 46. The output unit 43 can include, for example, a speaker.

The display unit 44 displays various types of information on the information processing terminal 40 and information on the hearing aid 2 under the control of the control unit 46. The display unit 44 can include, for example, a liquid crystal display and an organic electroluminescent (EL) display.

The storage unit 45 stores various types of information on the information processing terminal 40. The storage unit 45 stores various programs 451 and the like to be executed by the information processing terminal 40. The storage unit 45 can include, for example, a recording medium such as a RAM, a ROM, a flash memory, and a memory card.

The control unit 46 controls each unit constituting the information processing terminal 40. The control unit 46 can include, for example, a memory and a processor having hardware such as a CPU. The control unit 46 reads and executes a program stored in the storage unit 45 in a work area of the memory, and controls each component and the like through execution of the program performed by the processor.

Furthermore, the information processing terminal 40 may include a positioning sensor (not illustrated). The positioning sensor detects the position of the user carrying the information processing terminal 40, and can be specifically a global navigation satellite system (GNSS) receiver or the like. In this case, the positioning sensor can generate sensing data indicating the latitude and longitude of the current location of the user based on a signal from a GNSS satellite. Furthermore, in the embodiments of the present disclosure, a relative positional relation of the user can be detected from, for example, radio frequency identification (RFID), an access point of Wi-Fi, and information on a wireless base station. Such a communication device can thus be used as the above-described positioning sensor. In the embodiments of the present disclosure, the environment around the hearing aid 2 and the like may be estimated based on position information on the information processing terminal 40 close to the hearing aid 2.

Note that, in the embodiments of the present disclosure, the functional configurations of the hearing aid system 1 and each device included therein are not limited to the form in FIGS. 1 to 3. For example, as described later, the hearing aid system 1 may include an information processing server.

### 2. BACKGROUND

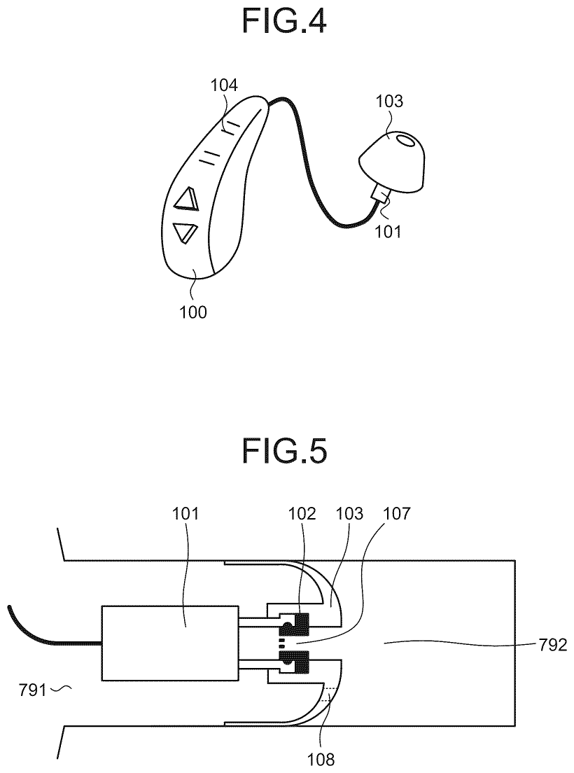

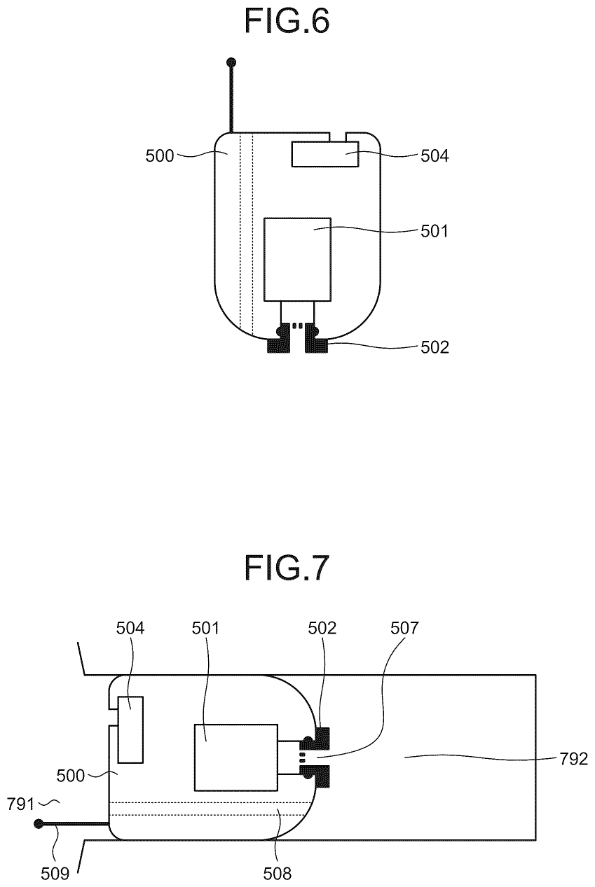

Next, before describing the embodiments of the present disclosure, the background with which the present inventors have created the embodiments of the present disclosure will be described. First, a specific form of the hearing aid 2 will be described with reference to FIGS. 4 to 7. FIG. 4 illustrates a configuration example of an ear hanging type hearing aid 100 according to the embodiments of the present disclosure. FIG. 5 is a cross-sectional view illustrating a state in which a receiver 101 of the ear hanging type hearing aid 100 according to the embodiments of the present disclosure is inserted into the ear canal of the user. FIG. 6 illustrates a configuration example of an ear hole type hearing aid 500 according to the embodiments of the present disclosure. FIG. 7 is a cross-sectional view illustrating a state in which the ear hole type hearing aid 500 according to the embodiments of the present disclosure is inserted into the ear canal of the user. Here, the hearing aid 100 is an ear hanging type hearing aid, and is referred to as, for example, behind-the-ear (BTE)/receiver-in-the-canal (RIC). Furthermore, the hearing aid 500 is an ear hole type hearing aid, and is referred to as, for example, in-the-ear (ITE)/in-the-canal (ITC)/completely in-the-canal (CIC)/invisible-in-the-canal (IIC). Note that the hearing aids 100 and 500 may be hearing aids of other than the above-described forms.

As illustrated in FIG. 4, the ear hanging type hearing aid 100 mainly includes a receiver (output unit) 101, an ear tip (attachment part) 103, and a first microphone (first sound collection unit) 104. The first microphone 104 collects ambient sounds, and transmits an acoustic signal to a signal processing unit (not illustrated). The above-described signal processing unit amplifies the transmitted acoustic signal in accordance with the hearing of the user, and transmits the acoustic signal to the receiver 101. The receiver 101 is a speaker that outputs the transmitted acoustic signal. Moreover, the ear tip 103 to be attached to the ear canal of the user is connected to the receiver 101. The ear tip 103 is also referred to as an ear dome. The ear tip 103 molded in accordance with the shape of an ear of each user is also referred to as an ear mold. Then, when using the hearing aid 100, the user hangs the hearing aid 100 from an auricle, and inserts the receiver 101 into an ear canal via the ear tip 103.

FIG. 5 illustrates a state in which the receiver 101 of the ear hanging type hearing aid 100 is inserted into the ear canal of the user. The ear tip 103 has a first hole 107 as a sound outlet of the receiver 101. Moreover, an earwax intrusion prevention filter 102 for preventing intrusion of earwax is provided in the first hole 107. Therefore, the sound outlet of the receiver 101 communicates with an ear canal inside 792 via the first hole 107 and the earwax intrusion prevention filter 102. Moreover, the ear tip 103 separates the ear canal inside 792 and an ear canal outside 791 of the user from each other. Then, the ear tip 103 may have a second hole 108 for preventing accumulation of voice of the user himself/herself and securing ventilation. The second hole 108 causes the ear canal inside 792 and the ear canal outside 791 to communicate with each other. Note that the second hole 108 is also referred to as a vent. For example, the first hole 107 commonly has a small diameter of approximately 1 mm. Furthermore, the presence or absence of the second hole 108 is often determined depending on the hearing of the user mainly in a low frequency range. The diameter of the second hole 108 such as approximately 1 mm and approximately 3 mm can be appropriately selected. Note that one or a plurality of second holes 108 may be provided. When there is a plurality of second holes 108, the second holes 108 may have the same diameter or different diameters. Furthermore, the hole may have a circular shape or a shape other than the circular shape. Moreover, one side or both sides of the second hole 108 may have a mesh structure.

Furthermore, as illustrated in FIG. 6, the ear hole type hearing aid 500 mainly includes a receiver 501 and a first microphone 504. The first microphone 504 collects ambient sound, and transmits an acoustic signal to a signal processing unit (not illustrated). The above-described signal processing unit amplifies the transmitted acoustic signal in accordance with the hearing of the user, and transmits the acoustic signal to the receiver 501. The receiver 501 outputs the transmitted acoustic signal. Then, when the user uses the hearing aid 500, the hearing aid 500 is inserted into the ear canal of the user.

FIG. 7 illustrates a state in which the ear hole type hearing aid 500 is inserted into the ear canal of the user. As described above, when the user uses the hearing aid 500, the hearing aid 500 is inserted into the ear canal of the user. A housing (housing portion), which is a main body of the hearing aid 500, incorporates the receiver 501 and the first microphone 504 described above. Moreover, when the hearing aid 500 is removed from the ear canal, the user pulls a string 509 connected to the housing. Note that no string 509 may be provided depending on the size of the ear hole type hearing aid 500.

Moreover, the housing has a first hole 507 as a sound outlet of the receiver 501. An earwax intrusion prevention filter 502 for preventing intrusion of earwax is provided in the first hole 507. Therefore, the sound outlet of the receiver 501 communicates with the ear canal inside 792 via the first hole 507 and the earwax intrusion prevention filter 502. Moreover, the first microphone 504 is provided at a position away from the first hole 507 by a predetermined distance. Furthermore, the ear canal inside 792 and the ear canal outside 791 of the user are separated from each other by the hearing aid 500. Then, the hearing aid 500 has a second hole 508 for preventing accumulation of voice of the user himself/herself and securing ventilation. The second hole 508 causes the ear canal inside 792 and the ear canal outside 791 to communicate with each other. For example, the first hole 507 commonly has a small diameter of approximately 1 mm. Furthermore, the presence or absence of the second hole 508 is often determined depending on the hearing of the user mainly in a low frequency range. The diameter of the second hole 508 such as approximately 1 mm and approximately 3 mm can be appropriately selected. Note that one or a plurality of second holes 508 may be provided. When there is a plurality of second holes 508, the second holes 508 may have the same diameter or different diameters. Furthermore, the hole may have a circular shape or a shape other than the circular shape. Moreover, one side or both sides of the second hole 508 may have a mesh structure.

Note that, in the embodiments of the present disclosure, the hearing aids 100 and 500 are not limited to having a form in FIGS. 4 to 7.

Moreover, the first hole 107 and the earwax intrusion prevention filter 102 will be described with reference to FIG. 5. As can be seen from FIG. 5, a sound output from the receiver 101 reaches the ear canal inside 792 via the first hole 107. Clogging of the first hole 107 with something, however, prevents an amplified sound from reaching the ear canal inside 792 as expected. The hearing aid 100 aids the hearing of the user. It may be a serious problem that an expected sound does not reach the ear canal of the user. Then, the first hole 107 is clogged most commonly with earwax.

Thus, the earwax intrusion prevention filter 102 is widely used to prevent earwax from intruding into the first hole 107 and blocking the first hole 107. Note that the earwax intrusion prevention filter 102 is also referred to as a wax guard, a wax trap, a wax filter, or the like.

Then, the earwax intrusion prevention filter 102 is a replaceable part. Usually, an expert (audiologist) adjusts (e.g., performs fitting on) and maintains the hearing aid 100. Therefore, the expert commonly checks the state of the earwax intrusion prevention filter 102 at the time of maintenance, and replaces the earwax intrusion prevention filter 102, as necessary. A replacement part of the earwax intrusion prevention filter 102 is, however, also sold to common users. The user himself/herself can replace the earwax intrusion prevention filter 102.

Moreover, the second hole 508 will be described with reference to FIG. 7. As can be seen from FIG. 7, the second hole 508 causes the ear canal inside 792 and the ear canal outside 791 of the user to communicate with each other. Clogging of the second hole 508 with something causes excessive accumulation of voice of the user himself/herself and insufficient ventilation. The excessive accumulation of voice of the user himself/herself may make the user not only feel uncomfortable, but have difficulty in issuing an utterance. Then, the second hole 508 is clogged most commonly with earwax.

Thus, the second hole 508 is cleaned with a cleaning brush (not illustrated) in order to prevent earwax from intruding into the second hole 508 and blocking the second hole 508. Usually, an expert adjusts and maintains the hearing aid 500. Therefore, the expert commonly checks the state of the second hole 508 at the time of maintenance, and cleans the second hole 508, as necessary. The cleaning brush is, however, sold to common users. The user himself/herself can perform cleaning.

As described above, when an expert performs maintenance at a hearing aid shop or the like, the expert can check and address the states of the earwax intrusion prevention filter 102 and the second hole 508. Therefore, it is possible to prevent the user from continuing to use the hearing aids 100 and 500 in a state in which the earwax intrusion prevention filter 102 and the second hole 508 are clogged with something.

In contrast, the hearing aids 100 and 500 may be sold at a shop without an expert. Such hearing aids 100 and 500 are called over-the-counter (OTC) hearing aids. Sufficient support of from an expert cannot be expected for such hearing aids 100 and 500. Therefore, in a case of an OTC hearing aid, the user himself/herself is required to check and address the states of the earwax intrusion prevention filter 102 and the second hole 508. Periodic replacement of the earwax intrusion prevention filter 102 may be prompted through the instructions and the like depending on hearing aids. If the user misses or forgets the instructions, the earwax intrusion prevention filter 102 is not replaced. Moreover, since the quality and amount of earwax greatly differ between individuals, the appropriate time to replace the earwax intrusion prevention filter 102 varies depending on users.

Thus, Patent Literature 1 above proposes a technique for solving such a problem. Specifically, in Patent Literature 1 above, the clogging of the earwax intrusion prevention filter is estimated based on the fact that the impedance of a receiver changes between a case where the earwax intrusion prevention filter is not clogged and a case where the earwax intrusion prevention filter is clogged. The user is notified of the estimation result. In a method proposed in Patent Literature 1 above, however, a sound output from the receiver is not directly examined. The method lacks reliability in terms of an influence on a sound, and has a limit in enhancing the accuracy of estimating the clogging of the earwax intrusion prevention filter.

Furthermore, although the clogging of the earwax intrusion prevention filter 102 and the second hole 508 has been described so far, the hearing aids 100 and 500 further have another problem. The problem is non-attachment of the earwax intrusion prevention filters 102 and 502 to be attached to the first holes 107 and 507. Appropriately attached earwax intrusion prevention filters 102 and 502 are less likely to be detached. Not appropriately attached earwax intrusion prevention filters 102 and 502 may be detached and lost. An elderly user often has poor vision, and tends not to notice the fact that a small part is not attached. If the loss is noticed, new earwax intrusion prevention filters 102 and 502 can be attached. If the loss is not noticed, the hearing aids 100 and 500 continue to be used without attaching the earwax intrusion prevention filters 102 and 502. When the hearing aids 100 and 500 are used without attaching the earwax intrusion prevention filters 102 and 502, earwax is highly likely to intrude into the receivers 101 and 501. Then, earwax that has intruded into the receivers 101 and 501 may cause failure of the hearing aids 100 and 500. Therefore, it is necessary to quickly cause the user to notice the non-attachment of the earwax intrusion prevention filters 102 and 502.

Moreover, the hearing aids 100 and 500 should be appropriately adjusted in accordance with the hearing of the user. Therefore, usually, an expert such as an audiologist calibrates the microphones 104 and 504 and the receivers 101 and 501 of the hearing aids 100 and 500 in an appropriate range. The microphones 104 and 504 and the receivers 101 and 501 may fail to be appropriately calibrated due to some causes such as the user erroneously dropping or submerging the hearing aids 100 and 500. Then, if the user does not notice the fact, the hearing aids 100 and 500 continue to be used in a state in which a sound deviating, as a result, from a sound appropriately matched with the hearing of the user is output, and an object of the hearing aid cannot be achieved. Therefore, it is necessary to quickly cause the user to notice that the microphones 104 and 504 and the receivers 101 and 501 are not appropriately calibrated.

Thus, in view of such a situation, the present inventors have created the embodiments of the present disclosure to be described below. According to the embodiments of the present disclosure, abnormalities of the hearing aids 100 and 500 can be easily and accurately detected. Note that examples of the abnormalities of the hearing aids 100 and 500 detected in the embodiments of the present disclosure include (clogging) of the first holes 107 and 507, an abnormality (clogging) of the second hole 108, abnormalities (clogging and non-attachment) of the earwax intrusion prevention filters 102 and 502 to be attached to the first holes 107 and 507, abnormalities of the receivers 101 and 501 (output units), and abnormalities of the microphones (first sound collection units) 104 and 504. The embodiments of the present disclosure created by the present inventors will be sequentially described below.

### 3. First Embodiment

### 3.1 Outline

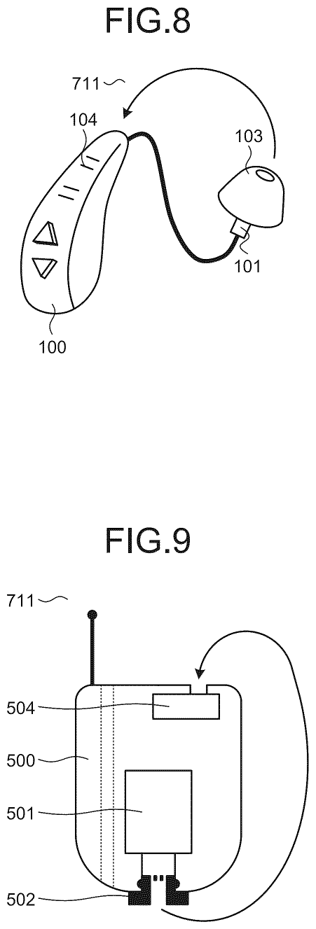

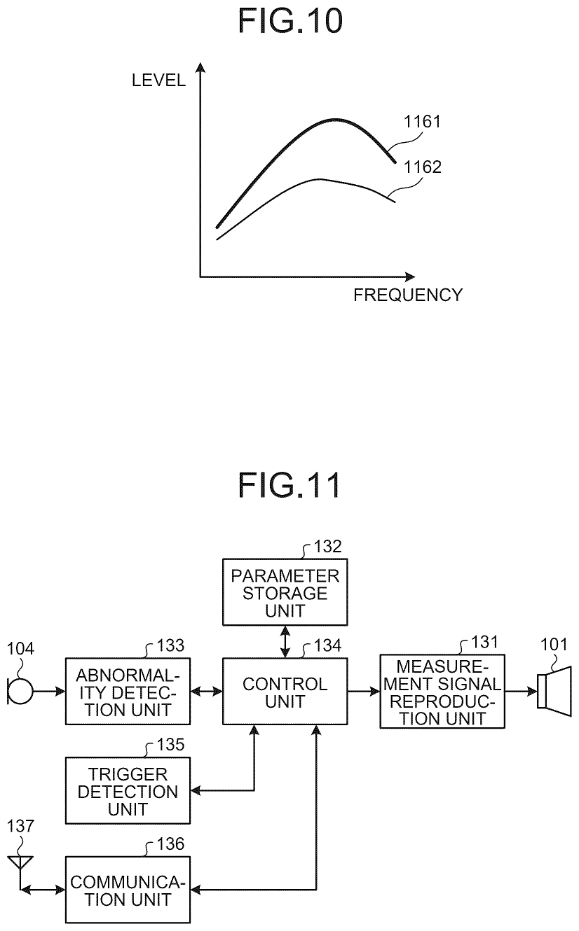

First, a first embodiment of the present disclosure will be outlined with reference to FIGS. 8 to 10. In the embodiment, clogging of the earwax intrusion prevention filters 102 and 502 provided in the first holes 107 and 507 is detected. FIG. 8 is an explanatory diagram illustrating an example of application to the ear hanging type hearing aid (information processing apparatus) 100 according to the embodiment. FIG. 9 is an explanatory diagram illustrating an example of application to the ear hole type hearing aid (information processing apparatus) 500 according to the embodiment. Moreover, FIG. 10 is an explanatory diagram illustrating an example of the characteristics of a measurement sound collected in the embodiment.

First, as illustrated in FIG. 8, when the embodiment is applied to the ear hanging type hearing aid 100, the hearing aid 100 outputs a measurement sound for detecting an abnormality from the receiver (output unit) 101 with reception of a trigger signal as a starting point. The measurement sound output from the receiver 101 is collected by the first microphone (first sound collection unit) 104 via the first hole 107 and space 711. Then, the first microphone 104 collects the measurement sound that has arrived via the space 711, and converts the measurement sound into an acoustic signal. Moreover, an abnormality detection unit of the hearing aid 100 to be described later detects clogging of the earwax intrusion prevention filter 102 provided in the first hole 107 based on the acoustic signal obtained by the conversion.

Furthermore, as illustrated in FIG. 9, when the embodiment is applied to the ear hole type hearing aid 500, the hearing aid 500 outputs a measurement sound for detecting an abnormality from the receiver 501 with reception of a trigger signal as a starting point. The measurement sound output from the receiver 501 is collected by the first microphone 504 via the first hole 507 and the space 711. Then, the first microphone 504 collects the measurement sound received via the space 711, and converts the measurement sound into an acoustic signal. Moreover, an abnormality detection unit of the hearing aid 500 to be described later detects clogging of the earwax intrusion prevention filter 502 provided in the first hole 507 based on the acoustic signal obtained by the conversion.

Note that a hearing aid to which the embodiment is applied may be the ear hanging type hearing aid 100 and the ear hole type hearing aid 500 as illustrated in FIGS. 8 and 9, or may be a hearing aid having a form other than the form in FIGS. 8 and 9. That is, the hearing aid to which the embodiment is applied is not particularly limited as long as the hearing aid includes a receiver that outputs a measurement sound with reception of a trigger signal as a starting point, a microphone that collects the output measurement sound and converts the measurement sound into an acoustic signal, and a functional unit that detects an abnormality by using the acoustic signal.

Then, the measurement sounds collected by the first microphones 104 and 504 exhibit characteristics (frequency characteristics) as illustrated in FIG. 10, for example. Specifically, when the earwax intrusion prevention filters 102 and 502 are not clogged, the measurement sounds output from the receivers 101 and 501 normally pass through the first holes 107 and 507. Therefore, when the measurement sounds output from the receivers 101 and 501 are collected by the first microphones 104 and 504 and converted into acoustic signals, the frequency characteristics of the acoustic signals obtained by the conversions correspond to a characteristic 1161 at the normal time in FIG. 10, for example.

In contrast, when the earwax intrusion prevention filters 102 and 502 are clogged, the measurement sounds output from the receivers 101 and 501 cannot normally pass through the first holes 107 and 507. Therefore, when the measurement sounds output from the receivers 101 and 501 are collected by the first microphones 104 and 504 and converted into acoustic signals, the frequency characteristics of the acoustic signals obtained by the conversions changes to a characteristic 1162 at the abnormal time in FIG. 10, for example. In the embodiment, the clogging of the earwax intrusion prevention filters 102 and 502 is detected by the difference between the characteristics of the measurement sounds collected by the first microphones 104 and 504 as described above. Note that the characteristics used in the embodiment is not limited to the frequency characteristics which indicate a change at a volume level with respect to a frequency change as illustrated in FIG. 10. The characteristics used in the embodiment is required to be characteristics indicating the features of the measurement sounds collected by the first microphones 104 and 504.

For example, a difference between the characteristics of measurement sounds caused by the presence or absence of clogging of the earwax intrusion prevention filters 102 and 502 is clarified by analyzing the characteristics of the measurement sounds collected in various states where the earwax intrusion prevention filters 102 and 502 are clogged by machine learning, statistical methods, and the like. Thus, in the embodiment, clogging of the earwax intrusion prevention filters 102 and 502 can be detected by using a model obtained by such analysis.

In the embodiment, an impulse, a time-stretched-pulse (TSP), a noise, a melody including a frequency necessary for measurement, a pure tone, a plurality of pure tones, and the like can be used as the measurement sounds. Furthermore, a sound whose frequency and volume change stepwise may be used as a measurement sound. Moreover, a plurality of sounds having different frequencies may be used as measurement sounds. For example, a plurality of sounds having different volumes and a plurality of sounds having different patterns may be used. Then, in the embodiment, when such a plurality of sounds is used, the sounds may be output simultaneously or at different timings.

### 3.2 Functional Configuration

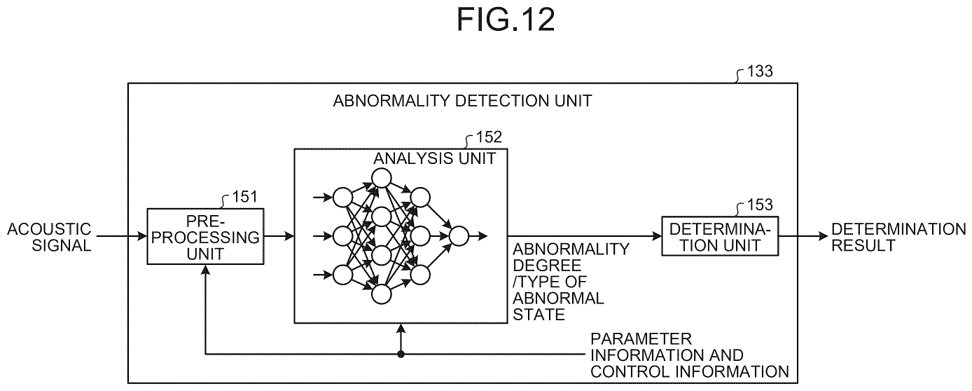

Next, a functional configuration of the hearing aid 100 in the embodiment will be described with reference to FIGS. 11 and 12. FIG. 11 is a functional block diagram of the hearing aid 100 according to the embodiment. FIG. 12 is a functional block diagram of an abnormality detection unit 133 according to the embodiment. Note that, although an example of the ear hanging type hearing aid 100 is described here, the ear hole type hearing aid 500 can also have a similar configuration in the embodiment.

As illustrated in FIG. 11, the hearing aid 100 according to the embodiment includes a measurement signal reproduction unit 131 and a parameter storage unit 132. The measurement signal reproduction unit 131 outputs a measurement sound to the receiver 101. The parameter storage unit 132 stores a program and data for controlling the hearing aid 100. Furthermore, the hearing aid 100 includes the abnormality detection unit 133 and a control unit 134. The abnormality detection unit 133 detects an abnormality based on a measurement sound collected by the first microphone 104. The control unit 134 controls each functional unit of the hearing aid 100. Moreover, the hearing aid 100 mainly includes a trigger detection unit (activation signal detection unit) 135 and a communication unit (example of notification unit) 136. The trigger detection unit 135 detects a trigger signal (activation signal) for starting abnormality detection. The communication unit 136 can communicate with the information processing terminal 40. Each functional block of the hearing aid 100 will be described below.

The measurement signal reproduction unit 131 can output a measurement sound to the receiver 101. The measurement signal reproduction unit 131 may use a parameter stored in the parameter storage unit 132 via the control unit 134 to reproduce the measurement sound. When the parameter is used, the frequency, volume, and pattern of the measurement sound can be adjusted based on a difference in the output capability of the receiver 101 and a difference in an environmental condition (e.g., whether ambient environmental sound is big or small) at the time of detecting an abnormality. In the case, the measurement signal reproduction unit 131 may detect and adjust the volume of an ambient sound with the first microphone 104 of the hearing aid 100. Alternatively, the measurement signal reproduction unit 131 may use position information on the information processing terminal 40 of the user close to the hearing aid 100 to detect, for example, whether the user is at home or out of home and make an adjustment. Note that, in the embodiment, when the hearing aid 100 is placed on a table or the like, the hearing aid 100 preferably outputs a stronger measurement sound than that in a case where the hearing aid 100 is stored in acoustically closed space such as a charger. This can enhance the accuracy of abnormality detection.

Furthermore, the parameter storage unit 132 stores a program and data for controlling the hearing aid 100. The program and data are stored at the time when the hearing aid 100 is shipped from a factory, for example. Furthermore, when a configuration change such as replacement of the receiver 101 is made by repair, the program and data may be updated at that time. Moreover, data (e.g., algorithm and model) used by the abnormality detection unit 133 to be described later may be updated by being distributed to the hearing aid 100 each time an update is made.

Then, the first microphone 104 collects the measurement sound output from the receiver 101. The first microphone 104 converts the sound into an acoustic signal, and sends the acoustic signal obtained by the conversion to the abnormality detection unit 133. The abnormality detection unit 133 detects an abnormality, that is, clogging of the earwax intrusion prevention filter 102 provided in the first hole 107 based on the acoustic signal from the first microphone 104. When detecting an abnormality, the abnormality detection unit 133 can use a parameter stored in the parameter storage unit 132 in the course of processing. Note that details of the abnormality detection unit 133 will be described later.

The control unit 134 instructs the measurement signal reproduction unit 131 to reproduce the measurement sound based on a trigger signal detected by the trigger detection unit 135. For example, when a lidded charger 3 that starts charging at the timing when the lid is closed is used, the charger 3 detects that the charger 3 houses the hearing aid 100 and charging has been started by the lid having been closed. Then, the charger 3 detects that charging from the charger 3 to the hearing aid 100 has started, and transmits a trigger signal to the hearing aid 100. Moreover, the trigger detection unit 135 of the hearing aid 100 receives the trigger signal, and instructs the measurement signal reproduction unit 131 to reproduce the measurement sound via the control unit 134.

Furthermore, in a case as described above, for example, if the charger 3 is configured to end charging at the timing when the lid is opened, the charger 3 detects that the charging has ended by the lid having been opened. Then, the charger 3 detects that charging from the charger 3 to the hearing aid 100 has ended, and transmits the trigger signal to the hearing aid 100. Moreover, the trigger detection unit 135 of the hearing aid 100 receives the trigger signal, and causes the measurement signal reproduction unit 131 to end reproduction of the measurement sound via the control unit 134.

Note that, in the embodiment, the trigger detection unit 135 is not limited to receiving a trigger signal from the charger 3. For example, the trigger detection unit 135 may receive a trigger signal by a user operating a button provided on the hearing aid 100. Furthermore, the trigger detection unit 135 may receive a trigger signal from the information processing terminal 40 or the like.

The communication unit 136 can transmit an abnormality detection result to an external device (charger 3 or information processing terminal 40) by using a communication antenna 137, for example. In the embodiment, the communication unit 136 is not limited to performing wireless communication using the communication antenna 137 and the like. The communication unit 136 may perform wired communication using a communication connector and the like.

Note that, in the embodiment, each functional unit of the hearing aid 100 is not limited to having a form in FIG. 11. Furthermore, although the abnormality detection unit 133 and the like have been described above as being provided in the hearing aid 100, the embodiment is not limited thereto. For example, instead of the hearing aid 100, an information processing server, a cloud, and the like (not illustrated) capable of communicating with the information processing terminal 40, the charger 3, the hearing aid 100, the information processing terminal 40, and the like may execute the whole or a part of the functions of the abnormality detection unit 133. This enables a compact configuration of the hearing aid 100, and can inhibit an increase in power consumption.

Next, a specific example of an operation of the abnormality detection unit 133 will be described. The abnormality detection unit 133 extracts a sound quality change feature amount (feature point) X related to a change in sound quality from an acoustic signal of a measurement sound, and quantifies, for example, a sound quality change peculiar to clogging of the earwax intrusion prevention filter 102.

Specifically, the abnormality detection unit 133 converts acoustic signals output from the first microphone 104 into power spectrum coefficients S₀, . . . , and S_{M-1} by using short-time Fourier transform, a linear predictive coding (LPC) method, and the like. M represents the order of a spectrum. Then, the sound quality change feature amount X can be determined by calculating a load sum of ratios of the spectrum coefficients S₀, . . . , and S_{M-1} and spectrum coefficients B₀, . . . , and B_{M-1} in accordance with Expression (1) below.

$$X = {\sum }_{m = 0}^{M - 1} {W}_{m} \frac{{S}_{m}}{{B}_{m}} + θ \qquad ( 1 )$$

Here, Wm is a load coefficient, and θ is a predetermined bias value. The load coefficient Wm and the bias value θ can be determined by using various statistical determination methods. In the embodiment, for example, the degrees of clogging of a large number of types of earwax intrusion prevention filters 102 are preliminarily and subjectively evaluated. A learning sample is prepared by combining a spectrum coefficient ratio with a desired feature amount value (e.g., 0.0 to 1.0). Moreover, a load linearly approximated by multiple regression analysis on the learning sample can be obtained to determine the load coefficient Wm and the bias value θ. Furthermore, in the embodiment, a neural network may be used instead of the multiple regression analysis. Determination methods such as the Bayesian estimation method and vector quantization may be used.

Furthermore, in the embodiment, a sound quality change feature amount X′ may be used instead of the sound quality change feature amount X. Specifically, the abnormality detection unit 133 determines the sound quality change feature amount X′ by calculating a load sum of differences between spectrum coefficients S₀, . . . , and S_{M-1} and spectrum coefficients B₀, . . . , and B_{M-1} in accordance with Expression (2) below.

$${X}^{′} = {\sum }_{m = 0}^{M - 1} {W}_{m}^{′} ( {S}_{m} - {B}_{m} ) + {θ}^{′} \qquad ( 2 )$$

Here, W′m is a load coefficient, and θ′ is a predetermined bias value.

Furthermore, in the embodiment, a sound quality feature amount X″ may be used instead of the sound quality change feature amount X. Specifically, the abnormality detection unit 133 determines the sound quality feature amount X″ by calculating a load sum of spectrum coefficients S₀, . . . , and S_{M-1} in accordance with Expression (3) below.

$${X}^{″} = {\sum }_{m = 0}^{M - 1} {W}_{m}^{″} {S}_{m} + {θ}^{″} \qquad ( 3 )$$

Here, W″m is a load coefficient, and θ″ is a predetermined bias value.

Subsequently, the abnormality detection unit 133 quantifies an abnormality degree based on a short-time amplitude A(t) and the sound quality change feature amount X of an acoustic signal output from the first microphone 104. Specifically, a length y1 at which the sound quality change feature amount X exceeds a predetermined threshold, a maximum value y2 of the sound quality change feature amount X, and an average value y3 of the sound quality change feature amount X are calculated, and used as feature vectors. Then, the abnormality detection unit 133 calculates a value z indicating the abnormality degree in accordance with Expression (4) below.

$$Z = {\sum }_{i = 1}^{3} {u}_{i} {y}_{i} + {u}_{0} \qquad ( 4 )$$

Here, uᵢ is a load coefficient, and u₀ is a predetermined bias value. The load coefficient uᵢ and the bias value u₀ can be determined by using various statistical determination methods. In the embodiment, for example, the degrees of clogging of a large number of types of earwax intrusion prevention filters 102 are preliminarily and subjectively evaluated. A learning sample is prepared by combining a feature vector and a desired score value (e.g., 0.0 to 1.0). Moreover, a load linearly approximated by multiple regression analysis on the learning sample can be obtained to determine the load coefficient uᵢ and the bias value u₀. Furthermore, in the embodiment, a neural network may be used instead of the multiple regression analysis. Determination methods such as the Bayesian estimation method and vector quantization may be used.

Furthermore, in calculating the value z indicating an abnormality degree, a maximum value y4 of the short-time amplitude A(t) and an average value y5 of the short-time amplitude A(t) of an acoustic signal output from the first microphone 104 may be further calculated, and used as feature vectors. Then, the abnormality detection unit 133 calculates the value z indicating the abnormality degree in accordance with Expression (5) below. Here, the abnormality degree indicates the degree of clogging of the earwax intrusion prevention filter 102.

$$Z = {\sum }_{i = 1}^{5} {u}_{i} {y}_{i} + {u}_{0} \qquad ( 5 )$$

Moreover, the abnormality detection unit 133 determines the presence or absence of an abnormality, that is, the presence or absence of clogging of the earwax intrusion prevention filter 102 in accordance with Expression (6) below.

z>th (6)

Here, th is a threshold for determining the presence or absence of an abnormality. A case where Expression (6) is satisfied can be determined as “abnormal” (earwax intrusion prevention filter 102 is clogged). A case where Expression (6) is not satisfied can be determined as “not abnormal” (earwax intrusion prevention filter 102 is not clogged). Furthermore, in the embodiment, for example, the degree of an abnormality may be determined in according with Expressions (7) and (8) below.

z>th1 (7)

th1≥z>th2 (8)

Here, th1 and th2 are thresholds for determining the degree of an abnormality. A case where Expression (7) is satisfied can be determined as “abnormal”. A case where Expression (8) is satisfied can be determined as “be cautious”. A case where both Expressions (7) and (8) are not satisfied can be determined as “not abnormal”. Furthermore, although two cases are provided in expression (6) and three cases are provided in Expressions (7) and (8), more cases may be provided in the embodiment. Moreover, in the embodiment, for example, an abnormality degree z may be multiplied by 100, and the result may be indicated as a percentage.

For example, the abnormality detection unit 133 calculates the abnormality degree z as described above, and outputs the calculated abnormality degree z. Note that, in the embodiment, the abnormality detection unit 133 is not limited to outputting the abnormality degree z, and may output types of abnormal states such as “abnormal” and “not abnormal”. Here, “abnormal” indicates that the earwax intrusion prevention filter 102 is clogged. “Not abnormal” indicates that the earwax intrusion prevention filter 102 is not clogged.

Although, in the method using Expressions (1) to (8) above, a configuration of explicitly determining a feature amount is used, a configuration using a model of deep machine learning may be used in the embodiment. In the embodiment, for example, the degrees of clogging of a large number of types of earwax intrusion prevention filters 102 are preliminarily and subjectively evaluated. A learning sample is prepared by combining an abnormality degree (e.g., 0.0 to 1.0) preliminarily assigned to the evaluation and an acoustic signal. Then, the abnormality detection unit 133 may detect an abnormality by using a learned model generated by machine learning using the prepared learning sample.

Moreover, a detailed configuration of the abnormality detection unit 133 will be described with reference to FIG. 12. As illustrated in FIG. 12, the abnormality detection unit 133 mainly includes, for example, a preprocessing unit 151, an analysis unit 152, and a determination unit 153.

The preprocessing unit 151 performs preprocessing on an acoustic signal, as necessary. Examples of the preprocessing include sampling rate conversion, frequency conversion, band division, level detection, standardization, and normalization. Note that, in the embodiment, the preprocessing unit 151 is not required to be provided.

The analysis unit 152 analyzes output from the preprocessing unit 151, and predicts an abnormality degree and a type of an abnormal state. For example, the analysis unit 152 may perform the processing in Expressions (1) to (5) above. Alternatively, in the embodiment, as described above, the degrees of clogging of a large number of types of earwax intrusion prevention filters 102 are preliminarily and subjectively evaluated. A learning sample is prepared by combining an abnormality degree (e.g., 0.0 to 1.0) preliminarily assigned to the evaluation and an acoustic signal. Then, the analysis unit 152 may predict the abnormality degree and the type of an abnormal state by using the learned model generated by machine learning using the prepared learning sample. As described above, in the embodiment, the accuracy of abnormality detection can be enhanced by using machine learning. Furthermore, the preprocessing unit 151 and the analysis unit 152 may acquire a parameter from the parameter storage unit 132 via the control unit 134, as necessary.

Moreover, the determination unit 153 determines the presence or absence of an abnormality, that is, the presence or absence of clogging of the earwax intrusion prevention filter 102 by using, for example, Expressions (6) to (8) above based on prediction results (analysis results) of the abnormality degree and the type of an abnormal state from the analysis unit 152. Note that, in the embodiment, the determination unit 153 is not required to be provided.

Note that, in the embodiment, each functional unit of the abnormality detection unit 133 is not limited to having a form in FIG. 12.

### 3.3 Information Processing Method

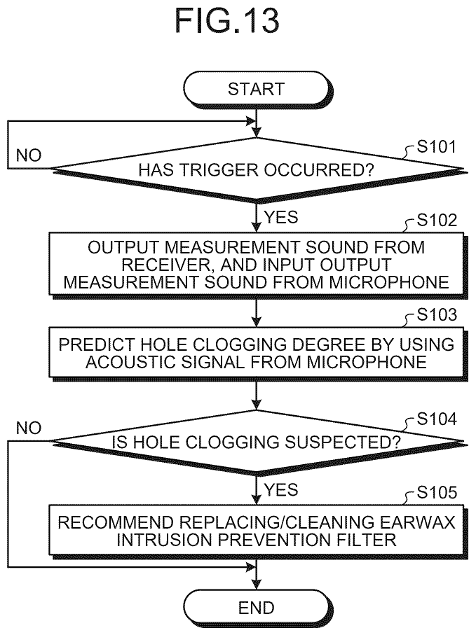

Next, an information processing method according to the embodiment will be described with reference to FIG. 13. FIG. 13 is a flowchart of the information processing method according to the embodiment. As illustrated in FIG. 13, the information processing method according to the embodiment includes a plurality of steps of Steps S101 to S105. Details of each step included in the information processing method according to the embodiment will be described below.

The hearing aid 100 determines whether a trigger has occurred (Step S101). When determining that a trigger has occurred (Step S101: Yes), the hearing aid 100 proceeds to Step S102, and starts measurement. In contrast, when determining that a trigger has not occurred (Step S101: No), the hearing aid 100 returns to Step S101, and stands by.

The hearing aid 100 outputs a measurement sound from the receiver 101, and the output measurement sound is input to the first microphone 104 (Step S102). Next, the hearing aid 100 predicts clogging of the earwax intrusion prevention filter 102 based on an acoustic signal from the first microphone 104 (Step S103).

The hearing aid 100 determines whether clogging of the earwax intrusion prevention filter 102 is suspected from the result of the clogging of the earwax intrusion prevention filter 102 predicted in Step S103 (Step S104). When clogging of the earwax intrusion prevention filter 102 is not suspected (Step S104: No), the hearing aid 100 ends the processing. In contrast, when clogging of the earwax intrusion prevention filter 102 is suspected (Step S104: Yes), the hearing aid 100 proceeds to Step S105.

Then, the hearing aid 100 gives notification to recommend the user to replace or clean the earwax intrusion prevention filter 102 (Step S105). In the embodiment, for example, notification given by a display unit of the charger 3 to be described later and notification through display, voice, and vibration output of the information processing terminal 40 of the user can be used as notification methods. Furthermore, in the embodiment, notification information may be stored. Next time, voice notification may be given to the user via the hearing aid 100 at the timing when the hearing aid 100 is attached to an ear of the user.

As described above, according to the embodiment, clogging of the earwax intrusion prevention filters 102 and 502 attached in the first holes 107 and 507 can be easily and accurately detected.

### 4. Second Embodiment

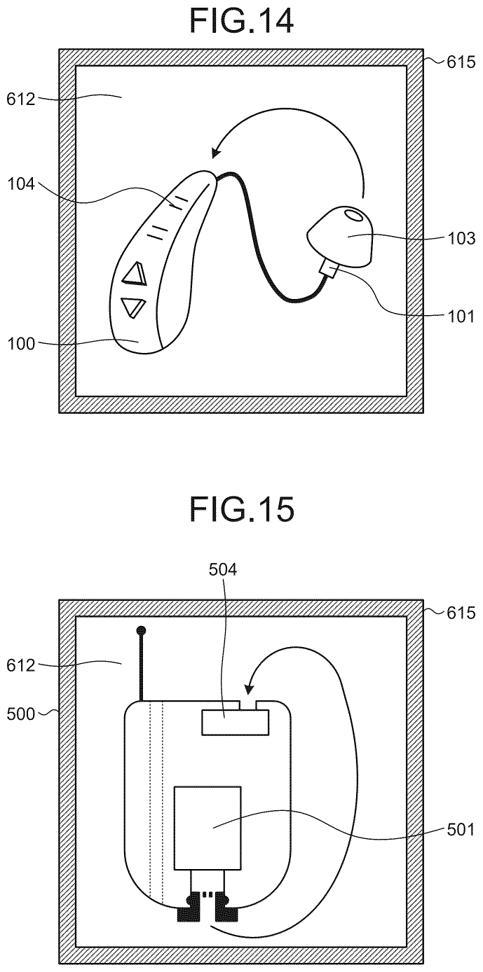

Next, a second embodiment of the present disclosure will be described with reference to FIGS. 14 and 15. The embodiment is different from the first embodiment in that the hearing aids 100 and 500 are stored in first closed space 612. FIG. 14 is an explanatory diagram illustrating an example of application to the ear hanging type hearing aid 100 according to the embodiment. FIG. 15 is an explanatory diagram illustrating an example of application to the ear hole type hearing aid 500 according to the embodiment.

Specifically, as illustrated in FIGS. 14 and 15, the first closed space 612 is acoustically closed with a first boundary 615 as a boundary. That is, sound transmission from the outside can be inhibited in the first closed space 612. In the embodiment, collection of a sound, which is not a measurement sound, mixed with a measurement sound performed by the first microphones 104 and 504 can be reduced by arranging the hearing aids 100 and 500 in the first closed space 612. Moreover, measurement sounds output from the receivers 101 and 501 efficiently reach the first microphones 104 and 504 without being diffused by arranging the hearing aids 100 and 500 in the first closed space 612. Consequently, according to the embodiment, the accuracy of abnormality detection can be enhanced.

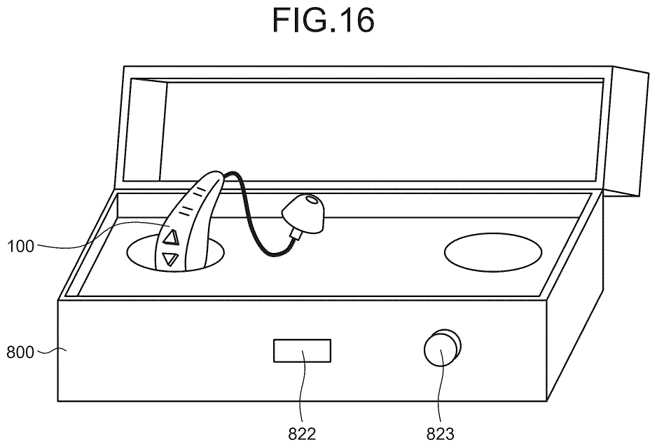

Moreover, an example in which the first closed space 612 is further embodied will be described with reference to FIG. 16. FIG. 16 is an explanatory diagram illustrating a configuration of a charger 800 that stores the hearing aid 100 in the embodiment.

As illustrated in FIG. 16, the charger 800 can store the hearing aid 100. The charger 800 has, for example, a lid, and has a structure (box structure) in which charging can be started by closing the lid. Therefore, when the lid of the charger 800 is closed, the charger 800 can play a role similar to that of the above-described first closed space 612. As a result, collection of a sound, which is not a measurement sound, mixed with a measurement sound performed by the first microphones 104 and 504 can be reduced by storing the hearing aids 100 and 500 in the charger 800. Moreover, measurement sounds output from the receivers 101 and 501 efficiently reach the first microphones 104 and 504 without being diffused by arranging the hearing aids 100 and 500 in the charger 800. Consequently, according to the embodiment, the accuracy of abnormality detection can be enhanced.

Furthermore, in the example of FIG. 16, as described above, abnormality detection is started (i.e., output of measurement sound is started) with the timing when the lid of the charger 800 is closed as a trigger. In the embodiment, the trigger is not limited to the timing when the lid is closed, and may be the timing when charging is started or the timing when charging is ended. The trigger is not particularly limited as long as the lid is closed.

Furthermore, in the embodiment, for example, a user operation on a button 823, which is operable from the outside, of the charger 800 with the lid being closed may be used as a trigger. Moreover, in the example of FIG. 16, the user can be notified of a result of abnormality detection via a display unit 822, which can be visually recognized from the outside, of the charger 800. For example, the display unit 822 can also give notification with color. For example, when there is no abnormality, blue is displayed. When there is an abnormality, red is displayed. Moreover, the display unit 822 may be enlarged to display characters, illustrations, animations, and the like.

Moreover, an advantage of detecting an abnormality in a state where the hearing aids 100 and 500 are stored in the charger 800 and the lid is closed is that a state in which the hearing aids 100 and 500 are not attached to an ear of the user can be reliably recognized. When the hearing aids 100 and 500 are not attached to an ear of the user, the user does not need to hear an unnecessary measurement sound. Moreover, since various selections can be made regarding a sound, volume (sound pressure level), and the like of a measurement sound, improvement in the accuracy of abnormality detection can be expected. Note that, when the above-described biological information sensor is provided in the hearing aids 100 and 500, the presence or absence of attachment of the hearing aids 100 and 500 can be detected based on sensing data from the biological information sensor as described above. Therefore, in the embodiment, non-attachment of the hearing aids 100 and 500 on an ear of the user may be confirmed by using the biological information sensor as described above to start abnormality detection.

Moreover, in the embodiment, the first closed space 612 is not limited to being the charger 800. For example, the first closed space 612 may be equipment that disinfects/sterilizes/dries the hearing aids 100 and 500, or may be a housing case for the hearing aids 100 and 500.

As described above, in the embodiment, collection of a sound, which is not a measurement sound, mixed with a measurement sound performed by the first microphones 104 and 504 can be reduced by arranging the hearing aids 100 and 500 in the first closed space 612. Moreover, measurement sounds output from the receivers 101 and 501 efficiently reach the first microphones 104 and 504 without being diffused by arranging the hearing aids 100 and 500 in the first closed space 612. Consequently, according to the embodiment, the accuracy of abnormality detection can be enhanced.

Note that, in the embodiment, for example, the hearing aid 100 may include an infrared (IR) sensor, an atmospheric pressure sensor, and an imaging sensor such as a camera in addition to the microphones. In the embodiment, whether the hearing aid 100 is stored in acoustically closed space such as a charger or placed in acoustically opened space may be determined by using these sensors. Moreover, in the embodiment, this enables control so as to output a stronger measurement sound when, for example, the hearing aid 100 is in the opened space than when the hearing aid 100 is stored in the closed space. Furthermore, in the embodiment, an output level of a measurement sound may be adjusted in accordance with a battery amount of the hearing aid 100. As a result, a battery of the hearing aid 100 can be saved by adjusting an optimum output level in accordance with the battery amount, and the hearing aid 100 can be used for a long time.

### 5. Third Embodiment

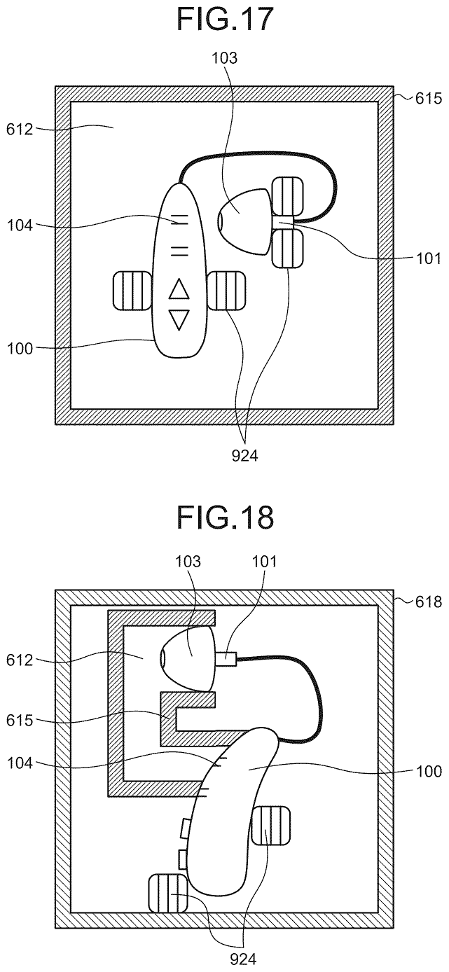

Next, a third embodiment of the present disclosure will be described with reference to FIGS. 17 and 18. The embodiment is different from the second embodiment in that a fixing portion for fixing the hearing aids 100 and 500 is provided in the first closed space 612 in order to keep acoustic characteristics at the time of abnormality detection constant. FIGS. 17 and 18 are explanatory diagrams illustrating examples of application to the ear hanging type hearing aid 100 according to the embodiment.

For example, as illustrated in FIG. 17, a fixing portion 924 is provided in the first closed space 612. The fixing portion 924 fixes the positional relation between the receiver 101 and the first microphone 104 in the first closed space 612. According to the embodiment, the positional relation between the receiver 101 and the first microphone 104 in the first closed space 612 is fixed, so that a measurement sound collected by the first microphone 104 is stabilized, and the accuracy of abnormality detection can be further enhanced.

Furthermore, as illustrated in FIG. 18, the fixing portion may have a tunnel structure in which closed space 612 is created by the first boundary 615. Specifically, the fixing portion is provided in a box structure indicated as a fourth boundary 618. The ear tip 103 is fitted into the fixing portion. The fixing portion can thereby be the first closed space 612 that causes the receiver 101 and the first microphone 104 to communicate with each other. According to the embodiment, this enables a measurement sound from the receiver 101 to be efficiently guided to the first microphone 104 while fixing the positional relation between the receiver 101 and the first microphone 104. As a result, according to the embodiment, the accuracy of abnormality detection can be further enhanced.

As described above, according to the embodiment, the positional relation between the receiver 101 and the first microphone 104 is fixed by providing the fixing portion 924, so that a measurement sound collected by the first microphone 104 is stabilized, and the accuracy of abnormality detection can be further enhanced. Note that, although the ear hanging type hearing aid 100 has been described here, the embodiment can be applied similarly to the ear hole type hearing aid 500.

### 6. Fourth Embodiment

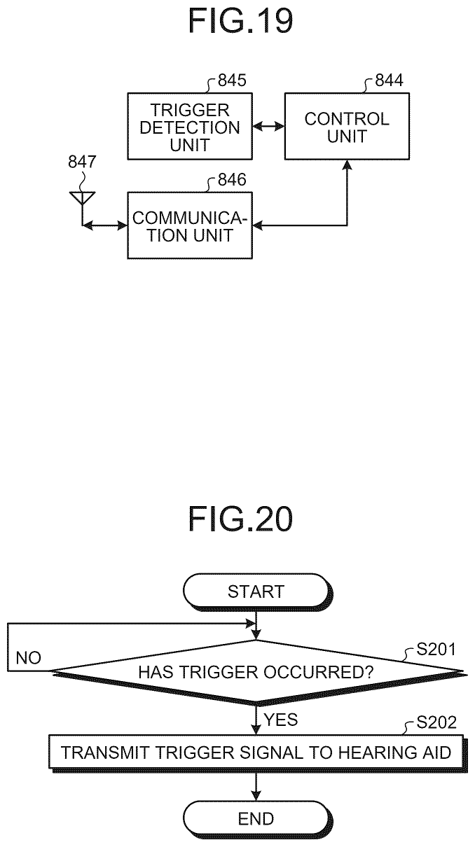

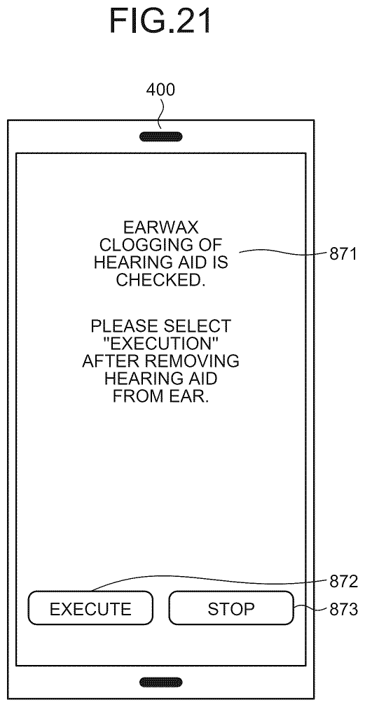

Next, a trigger detection function according to a fourth embodiment of the present disclosure will be described with reference to FIGS. 19 to 21. FIG. 19 is a functional block diagram in the trigger detection function of the charger 800 according to the embodiment. FIG. 20 is a flowchart of the information processing method according to the embodiment. Moreover, FIG. 21 is an explanatory diagram illustrating a notification example according to the embodiment.

Functional blocks that execute the trigger detection function as illustrated in FIG. 19 can be applied to, for example, the charger 800. The charger 800 mainly includes a control unit 844, a trigger detection unit 845, and a communication unit 846. Specifically, the trigger detection unit 845 can detect that the lid of the charger 800 is closed, and output a trigger signal. Alternatively, the trigger detection unit 845 may detect that an operation is performed on a button 823 of the charger 800 in FIG. 16, and output a trigger signal. In the embodiment, for example, an utterance of the user or voice (e.g., wake word) from the user may be detected as a trigger. A trigger signal may then be output.

The control unit 844 receives the trigger signal from the trigger detection unit 845, and outputs the trigger signal to the communication unit 846. For example, the communication unit 846 can transmit the trigger signal to the hearing aids 100 and 500 by using a communication antenna 847. In the embodiment, the communication unit 846 is not limited to performing wireless communication using the communication antenna 847 and the like. The communication unit 846 may perform wired communication using a communication connector and the like. Then, the hearing aids 100 and 500 that have received the trigger signal start outputting a measurement sound in order to detect an abnormality.

Note that, in the embodiment, when detecting that the lid of the charger 800 is opened, the trigger detection unit 845 may output a trigger signal for stopping abnormality detection to the hearing aids 100 and 500 as described above.

Note that, in the embodiment, a device that transmits a trigger signal to the hearing aids 100 and 500 is not limited to the charger 800, and may be an external device, a relay device, and the like such as the information processing terminal 40 and the information processing server (not illustrated).

Next, an information processing method according to the embodiment will be described with reference to FIG. 20. As illustrated in FIG. 20, the information processing method according to the embodiment includes Steps S201 and S202. Details of each step included in the information processing method according to the embodiment will be described below.

First, the charger 800 determines whether a trigger has occurred (Step S201). Examples of a trigger to be detected include closing of a lid and opening of the lid in a case of a lidded charger. When a trigger has occurred (Step S201: Yes), the charger 800 proceeds to Step S202. When a trigger has not occurred (Step S201: No), the charger 800 returns to Step S201. Then, the charger 800 transmits the trigger signal to the hearing aid 100 (Step S202).

The embodiment is not limited to detecting an abnormality based on the trigger signal from the charger 800 as described above. For example, an abnormality may be detected based on a trigger signal from the information processing terminal 40 used by the user. Specifically, for example, the information processing terminal 40 preliminarily stores the timing of the previous abnormality detection by using a user input or a signal from the hearing aids 100 and 500, and measures an elapsed time from the previous abnormality detection and a use time with a timer or the like. Moreover, when a predetermined time has elapsed, the information processing terminal 40 transmits the trigger signal to the hearing aid 100. Alternatively, in the embodiment, the user and the like may preliminarily register a specific date and time for detecting an abnormality by using a calendar. The information processing terminal 40 may transmit the trigger signal to the hearing aids 100 and 500 based on the registration. Alternatively, in the embodiment, the information processing terminal 40 may transmit the trigger signal to the hearing aid 100 in response to an instruction from a server (not illustrated) from a support service company.

Then, in the embodiment, the user is desirably guided to remove the hearing aids 100 and 500 from his/her ear before abnormality detection is executed. For example, as illustrated in FIG. 21, an information processing terminal 400 displays, to the user, a message 871 such as “Earwax clogging of the hearing aid is checked. Please select execution after removing the hearing aid from the ear”. Then, the information processing terminal 400 acquires a reply from the user by using buttons 872 and 873. Moreover, the information processing terminal 400 transmits the trigger signal to the hearing aid 100 in accordance with the reply from the user.

### 7. Fifth Embodiment

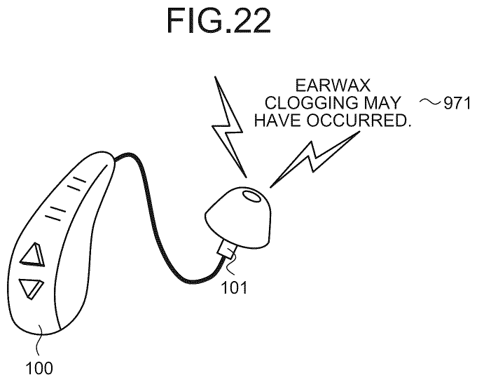

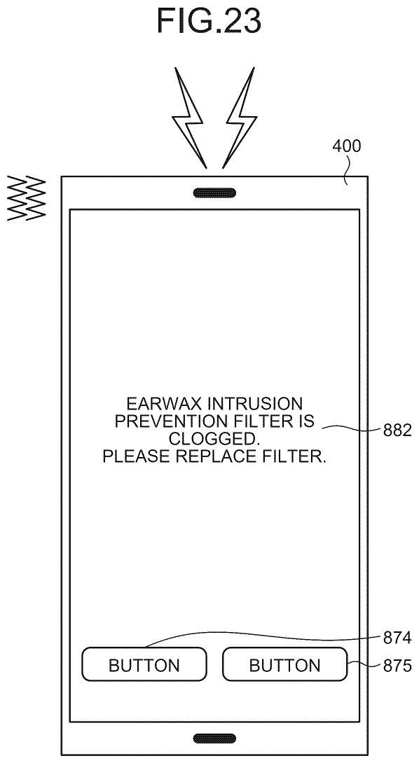

Next, as a fifth embodiment of the present disclosure, notification in a case where an abnormality is detected will be described with reference to FIGS. 22 and 23. FIGS. 22 and 23 are explanatory diagrams illustrating a notification example according to the embodiment.

In the example of FIG. 22, notification of a result of abnormality detection is given by outputting a message 971 such as “Earwax clogging may have occurred” from the receiver 101 of the hearing aid 100. Here, the receiver 101 outputs the message 971 by using voice or sound. For example, the user is notified of the result at the timing when the hearing aid 100 is estimated to be attached to the user, such as 10 seconds after the timing when the hearing aid 100 is turned on and 10 seconds after the timing when the hearing aid 100 is removed from the charger 800. Moreover, when the above-described biological information sensor is provided in the hearing aid 100, the attachment of the hearing aid 100 may be confirmed based on sensing data from the biological information sensor as described above, and the message 971 may be output. In the embodiment, this enables the user to check the result of abnormality detection of the hearing aid 100 without using the information processing terminal 400 and the like, so that even a user who does not frequently use the information processing terminal 400 can prevent a situation in which the user does not notice notification. Note that, in the example, when the message 971 is output from the receiver 101 of the hearing aid 100, notification is preferably given before the earwax intrusion prevention filter 102 is completely clogged.

Furthermore, in the embodiment, for example, a vibrator may be mounted in the hearing aid 100, and vibration may be used as a message (tactile message) instead of a voice message (auditory message). Alternatively, in the embodiment, a display device such as a light-emitting diode (LED) may be mounted on the hearing aid 100, and a color change or the display content of the display device may be used as a message (visual message).

In the example of FIG. 23, the information processing terminal 400 notifies the user of abnormality detection by displaying a message 882 such as “The earwax intrusion prevention filter is clogged. Please replace the filter”. In the embodiment, the message 882 may be a character message as illustrated in FIG. 23, or may be a message of an illustration, a symbol, an animation, and the like. Moreover, the user may provide feedback indicating that a notification has been checked to the information processing terminal 400 by operating buttons 874 and 875 on a screen. Furthermore, for example, the user may cause the information processing terminal 400 to display a figure and a video illustrating a method of replacing the earwax intrusion prevention filter 102 by operating the buttons 874 and 875 on the screen. Alternatively, in the embodiment, the information processing terminal 400 may be connected to a server (not illustrated) of a support service company or a support telephone line. In the embodiment, such notification enables the user to easily check the method of replacing the earwax intrusion prevention filter 102, so that the user can replace the earwax intrusion prevention filter 102 without feeling unsure in a procedure.

Moreover, in the embodiment, output of a message is not limited to being performed by the hearing aid 100 and the information processing terminal 400, and may be performed by the charger 800, information equipment (not illustrated) such as a television installed around the user, and an information processing terminal (not illustrated) of a family of the user. Moreover, in the embodiment, the forms of output of messages from these pieces of equipment are also not limited. A voice message (auditory message), vibration (tactile message), a display message (visual message), and the like can be appropriately selected.

### 8. Sixth Embodiment

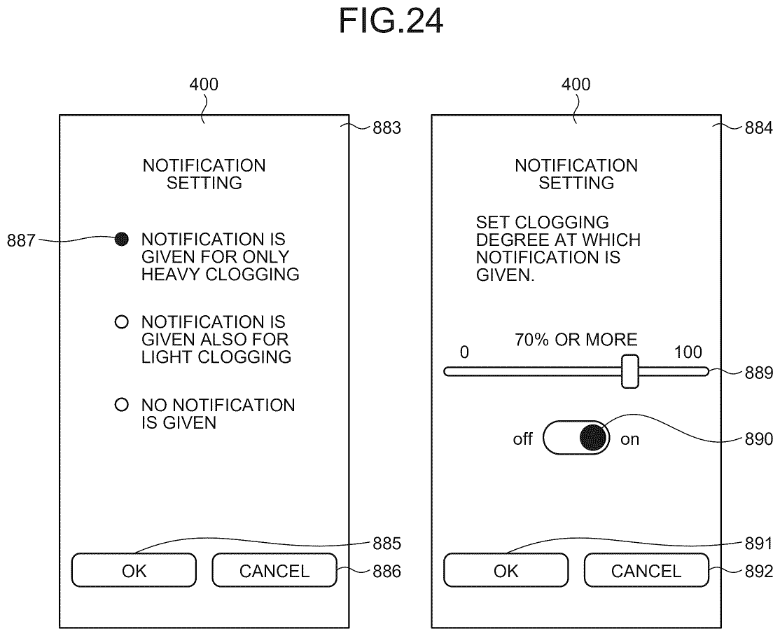

Next, as a sixth embodiment of the present disclosure, a setting regarding abnormality notification will be described with reference to FIG. 24. FIG. 24 is an explanatory diagram illustrating a notification setting screen according to the embodiment. In the embodiments of the present disclosure described above, the user can be notified of the presence or absence of an abnormality of the hearing aid 100 and the degree of the abnormality. Thus, in the embodiment, the user can set a level of an abnormality which the user is to be notified of. For example, as illustrated on the left side of FIG. 24, the user selects a radio button 887 in a display screen 883 displayed on a display unit of the information processing terminal 400. The user can thereby set notification at a level which the user desires from “notification is given for only heavy clogging”, “notification is given also for light clogging”, and “no notification is given”. Moreover, in order to enable selection of the radio button 887 made by the user, for example, a button 885 in the display screen 883 is required to be operated. Furthermore, in order to cancel selection of the radio button 887 made by the user, for example, a button 886 in the display screen 883 is required to be operated.

Furthermore, for example, as illustrated on the right side of FIG. 24, the user slides a slider bar 889 in a display screen 884 displayed on the display unit of the information processing terminal 400. The user can thereby make a setting to give notification at a level of clogging of the earwax intrusion prevention filter 102 which the user desires. Furthermore, for example, the user can also set the presence or absence of notification by using a switch 890 in the display screen 884. Moreover, in order to enable the setting of the slider bar 889 made by the user, for example, a button 891 in the display screen 884 is required to be operated. Furthermore, in order to cancel the setting of the slider bar 889 made by the user, for example, a button 892 in the display screen 884 is required to be operated.

Furthermore, in the embodiment, the presence or absence of execution of abnormality detection may be set, or a notification destination (e.g., charger 800 and information processing terminal 400) may be set as a setting regarding abnormality notification. Moreover, in the embodiment, a notification method (e.g., voice, lamp display, and screen display) or a notification destination may be set in accordance with a level of clogging of the earwax intrusion prevention filter 102.

### 9. Seventh Embodiment

### 9.1 Outline

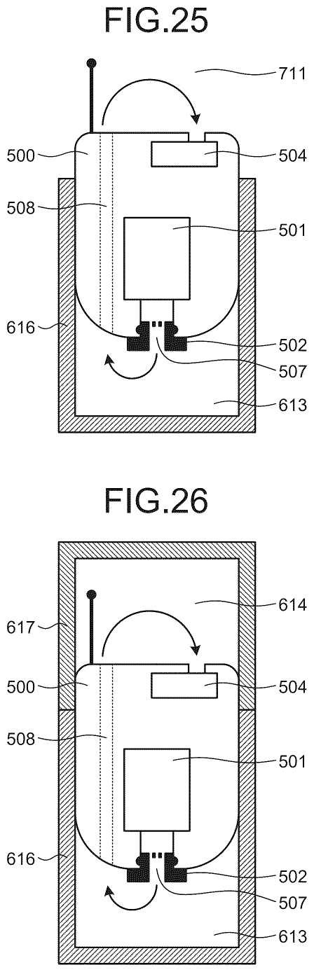

In a seventh embodiment of the present disclosure, clogging of the second hole 508 is predicted in addition to clogging of the earwax intrusion prevention filter 502 of the first hole 507. The embodiment will be described with reference to FIGS. 25 and 26. FIG. 25 is an explanatory diagram illustrating an example of application to the ear hole type hearing aid 500 according to the embodiment. FIG. 26 is an explanatory diagram illustrating a variation of application to the ear hole type hearing aid 500 according to the embodiment. Note that, although an example of the ear hole type hearing aid 500 is described here, the ear hanging type hearing aid 100 can also have a similar configuration in the embodiment.

First, as illustrated in FIG. 25, the hearing aid 500 outputs a measurement sound for abnormality detection from the receiver 501. The measurement sound output from the receiver 501 is collected by the first microphone 504 via the first hole 507, second closed space 613, the second hole 508, and the space 711. Then, the sound collected by the first microphone 504 is converted into an acoustic signal, and used for prediction in abnormality detection. Here, the second closed space 613 is acoustically closed with a second boundary 616 as a boundary. In the embodiment, the first microphone 504 can collect the measurement sound via the second hole 508 by arranging the receiver 501 and the first microphone 504 in other space with the second boundary 616 as a boundary. Then, in the embodiment, the first microphone 504 collects a sound via the second hole 508, so that clogging of the second hole 508 can be detected.

FIG. 26 illustrates the variation of the embodiment. A difference from the example of FIG. 25 is that one end surface of the second hole 508 and the first microphone 504 are arranged in the same third closed space 614. The third closed space 614 is acoustically closed with a third boundary 617 as a boundary. In the embodiment, one end surface of the second hole 508 and the first microphone 504 are arranged in the third closed space 614. Collection of a measurement sound mixed with another sound performed by the first microphone 504 can be thereby reduced. Moreover, one end surface of the second hole 508 and the first microphone 504 are arranged in the third closed space 614. Therefore, diffusion of measurement sounds that have passed through the second hole 508 can be prevented, and the first microphone 504 can efficiently collect the measurement sounds. As a result, according to the embodiment, the accuracy of abnormality detection can be enhanced.

The functional units of the hearing aid 100 of the first embodiment in FIG. 11 can execute the embodiment. In the embodiment, however, a measurement sound passes through two holes of the first hole 507 and the second hole 508, so that the characteristics of the measurement sound may be different from the characteristics in FIG. 10. Thus, in the embodiment, the parameter storage unit 132 in FIG. 11 stores the characteristics of the measurement sound passing through the two holes of the first hole 507 and the second hole 508. Then, the abnormality detection unit 133 can predict clogging of the second hole 508 in addition to clogging of the earwax intrusion prevention filter 502 of the first hole 507 by using the stored characteristics. Furthermore, in the embodiment, abnormality detection may be performed a plurality of times by using a plurality of measurement sounds. Moreover, in the embodiment, when abnormality detection is performed a plurality of times, a parameter used in the measurement signal reproduction unit 131 and the abnormality detection unit 133 may be changed for each measurement.

### 9.2 Information Processing Method

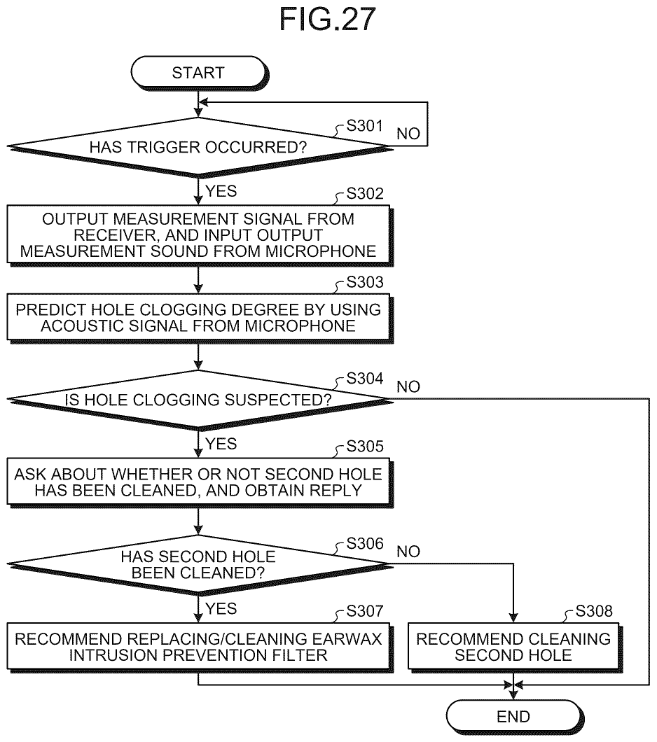

Next, an information processing method according to the embodiment will be described with reference to FIG. 27. FIG. 27 is a flowchart of the information processing method according to the embodiment. As illustrated in FIG. 27, the information processing method according to the embodiment includes a plurality of steps of Steps S301 to S308. Details of each step included in the information processing method according to the embodiment will be described below. Note that Steps S301 to S303 of the embodiment are similar to Steps S101 to S103 of the first embodiment in FIG. 11, and thus description thereof is omitted here.

The hearing aid 500 determines whether hole clogging is suspected from the hole clogging degree predicted in Step S303 above (Step S304). When hole clogging is not suspected (Step S304: No), the hearing aid 500 ends the processing. Furthermore, when hole clogging is suspected (Step S304: Yes), the hearing aid 500 proceeds to Step S305.

Next, the hearing aid 500 asks the user whether or not the second hole 508 has been cleaned, and obtains a reply (Step S305). Here, the information processing terminal 400 can be used to ask the user and receive a reply from the user. In the embodiment, for example, the user may input a reply via the display unit 44 of the information processing terminal 400, or the user may directly input a reply by voice using voice recognition or the like. Furthermore, a reply may be input not via the information processing terminal 400 but via the button 823 or the like provided in the charger 800. Moreover, when the user periodically uploads data such as a cleaning history to an external server or the like, the data can be used as a reply.

The hearing aid 500 determines whether the second hole 508 has been cleaned based on the reply of the user (Step S306). When the reply from the user indicates that the second hole 508 has not been cleaned (Step S306: No), the hearing aid 500 proceeds to Step S308. In contrast, when the reply from the user indicates that the second hole 508 has been cleaned (Step S306: Yes), the hearing aid 500 proceeds to Step S307.

Then, when the reply from the user indicates that the second hole 508 has been cleaned, the hearing aid 500 gives notification to recommend the user to replace or clean the earwax intrusion prevention filter 102 (Step S307). In contrast, when the reply from the user indicates that the second hole 508 has not been cleaned, the second hole 508 may be clogged. The hearing aid 500 thus gives notification to recommend the user to clean the second hole 508 (Step S308). Note that the information processing terminal 400, the charger 800, and the like can be used for the notification in Steps S307 and S308.

In the flowchart of FIG. 27, the user is preferentially recommended to clean the second hole 508. The second hole 508 can be easily cleaned only by passing a cleaning brush through the second hole 508. In contrast, since a new part is necessary for replacing the earwax intrusion prevention filter 502, unnecessary replacement is desirably avoided as much as possible. Thus, in the flowchart of FIG. 27, the user is preferentially recommended to clean the second hole 508. The embodiment is, however, not limited to the above-described order. In the embodiment, for example, when the user himself/herself can check clogging of the second hole 508 and clogging of the earwax intrusion prevention filter 502, the user may be recommended to check the clogging of the second hole 508 and the clogging of the earwax intrusion prevention filter 502 in Step S305 in FIG. 27.

As described above, according to the embodiment, clogging of the second hole 508 can be easily and accurately detected.

### 10. Eighth Embodiment

### 10.1 Outline

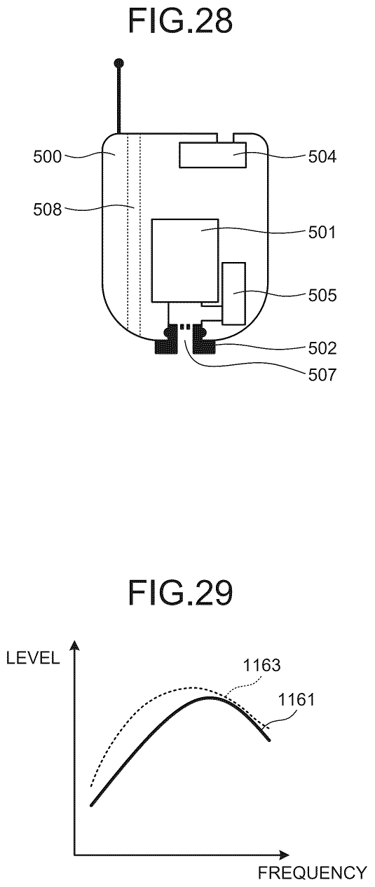

In an eighth embodiment of the present disclosure, clogging of the earwax intrusion prevention filter 502 of the first hole 507 is detected by using a second microphone 505 provided in the hearing aid 500. The embodiment will be described with reference to FIGS. 28 and 29. FIG. 28 is an explanatory diagram illustrating an example of application to the ear hole type hearing aid 500 according to the embodiment. FIG. 29 is an explanatory diagram illustrating an example of the characteristics of a measurement sound collected in the embodiment. Note that, although an example of the ear hole type hearing aid 500 is described here, the ear hanging type hearing aid 100 can also have a similar configuration in the embodiment.

In the embodiment, as illustrated in FIG. 28, a second microphone (second sound collection unit) 505 is provided adjacent to the receiver 501 in the hearing aid 500. Then, in the embodiment, a measurement sound for abnormality detection is output from the receiver 501. The measurement sound output from the receiver 501 is collected by the second microphone 505 via the first hole 507. The sound collected by the second microphone 505 is converted into an acoustic signal, and used for abnormality detection. Since being provided at a position closer to the first hole 507 than the first microphone 504, the second microphone 505 is less influenced by external sounds and environmental sounds. Therefore, in the embodiment, the accuracy of abnormality detection can be further enhanced by using an acoustic signal collected by the second microphone 505.

FIG. 29 illustrates an example of the characteristics of a measurement sound collected by the second microphone 505. Specifically, for example, a frequency characteristic in a case where the first hole 507 is not clogged is the characteristic 1161. A frequency characteristic in a case where the first hole 507 is clogged is a characteristic 1163. When the first hole 507 is clogged, the first hole 507 is almost closed space or the closed space. The level of the measurement sound collected by the second microphone 505 changes as in the characteristic 1163, for example. A difference between the characteristics of measurement sounds caused by the presence or absence of clogging of the first hole 507 is clarified by analyzing the characteristics of the measurement sounds collected in various states where the first hole 507 is clogged by machine learning, statistical methods, and the like. Thus, in the embodiment, the clogging of the first hole 507 is detected by the difference between the characteristics of the measurement sounds collected by the second microphone 505.

### 10.2 Variation

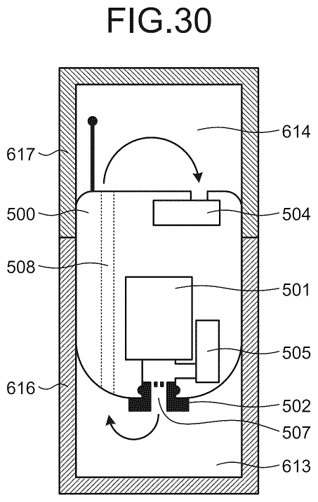

FIG. 30 is an explanatory diagram illustrating a variation of application to the ear hole type hearing aid 500 according to the embodiment. A difference from the example of FIG. 28 is that clogging of the second hole 508 can also be detected. Moreover, clogging of the first hole 507 can be detected regardless of the presence or absence of clogging of the second hole 508 by using the first microphone 504 and the second microphone 505 in combination. Specifically, in the variation, the hearing aid 500 outputs a measurement sound for abnormality detection from the receiver 501. The measurement sound output from the receiver 501 is collected by the first microphone 504 via the second closed space 613, the second hole 508, and the third closed space 614. Moreover, the measurement sound output from the receiver 501 is collected also by the second microphone 505. The measurement sounds collected by the first microphone 504 and the second microphone 505 are converted into acoustic signals, and used for abnormality detection.

### 10.3 Functional Configuration

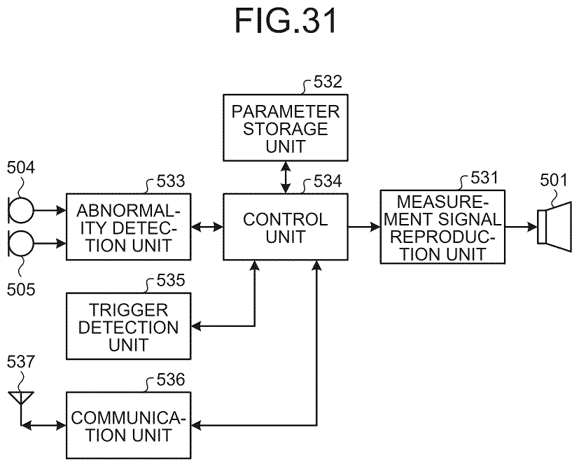

Next, a functional configuration of the hearing aid 500 in the embodiment will be described with reference to FIG. 31. FIG. 31 is a functional block diagram of the hearing aid 500 according to the embodiment. As illustrated in FIG. 31, the hearing aid 500 according to the embodiment includes a measurement signal reproduction unit 531 and a parameter storage unit 532. The measurement signal reproduction unit 531 outputs a measurement sound to the receiver 501. The parameter storage unit 532 stores a program and data for controlling the hearing aid 500. Furthermore, the hearing aid 500 includes an abnormality detection unit 533 and a control unit 534. The abnormality detection unit 533 detects an abnormality based on measurement sounds collected by the first microphone 504 and the second microphone 505. The control unit 534 controls each functional unit of the hearing aid 500. Moreover, the hearing aid 500 mainly includes a trigger detection unit 535 and a communication unit 536. The trigger detection unit 535 detects a trigger signal for starting abnormality detection. The communication unit 536 can communicate with the information processing terminal 400. Note that description of functional units common to those of the first embodiment will be omitted here.

In the embodiment, as illustrated in FIG. 31, the first microphone 504 and the second microphone 505 collect the measurement sounds output from the receiver 501, convert the measurement sounds into acoustic signals, and outputs the acoustic signals obtained by the conversion to the abnormality detection unit 533. Then, the abnormality detection unit 533 detects an abnormality by using the acoustic signals from the first microphone 504 and the second microphone 505.

In the embodiment, a specific configuration example of the abnormality detection unit 533 can be similar to that of the first embodiment. In the embodiment, for example, the abnormality detection unit 533 can separately process an acoustic signal from the first microphone 504 and an acoustic signal from the second microphone 505 to detect an abnormality. Alternatively, in the embodiment, the abnormality detection unit 533 may process an acoustic signal from the first microphone 504 and an acoustic signal from the second microphone 505 in combination to detect an abnormality.

When the abnormality detection unit 533 detects an abnormality by combining acoustic signals from the first microphone 504 and the second microphone 505, for example, Expression (5) above can be rewritten as Expression (9).

Specifically, the acoustic signal from the first microphone 504 is expressed by a sound quality change feature amount X1 and a short-time amplitude A1(t). The acoustic signal of the second microphone 505 is expressed by a sound quality change feature amount X2 and a short-time amplitude A2(t). Then, the abnormality detection unit 533 quantifies an abnormality degree based on the sound quality change feature amounts X1 and X2 and the short-time amplitudes A1(t) and A2(t) as described above. Specifically, the length y1 at which the sound quality change feature amount X1 exceeds a predetermined threshold, the maximum value y2 of the sound quality change feature amount X1, the average value y3 of the sound quality change feature amount X1, the maximum value y4 of the short-time amplitude A1(t), the average value y5 of the short-time amplitude A1(t), a length y6 at which the sound quality change feature amount X2 exceeds a predetermined threshold, a maximum value y7 of the sound quality change feature amount X2, an average value y8 of the sound quality change feature amount X2, a maximum value y9 of the short-time amplitude A2(t), and an average value y10 of the short-time amplitude A2(t) are calculated as feature vectors. Then, the abnormality detection unit 533 calculates the value z indicating an abnormality degree in accordance with Expression (9) below.

$$Z = {\sum }_{i = 1}^{10} {u}_{i} {y}_{i} + {u}_{0} \qquad ( 9 )$$

Here, uᵢ is a load coefficient, and u₀ is a predetermined bias value. The load coefficient uᵢ and the bias value u₀ can be determined by using various statistical determination methods. For example, the degrees of clogging of a large number of types of first holes 507 and/or second holes 508 are preliminarily and subjectively evaluated. A learning sample is prepared by combining a feature vector and a desired score value (e.g., 0.0 to 1.0). Moreover, a load linearly approximated by multiple regression analysis on the learning sample can be obtained to determine the load coefficient uᵢ and the bias value u₀. Furthermore, in the embodiment, a neural network may be used instead of the multiple regression analysis. Determination methods such as the Bayesian estimation method and vector quantization may be used.

### 10.4 Information Processing Method

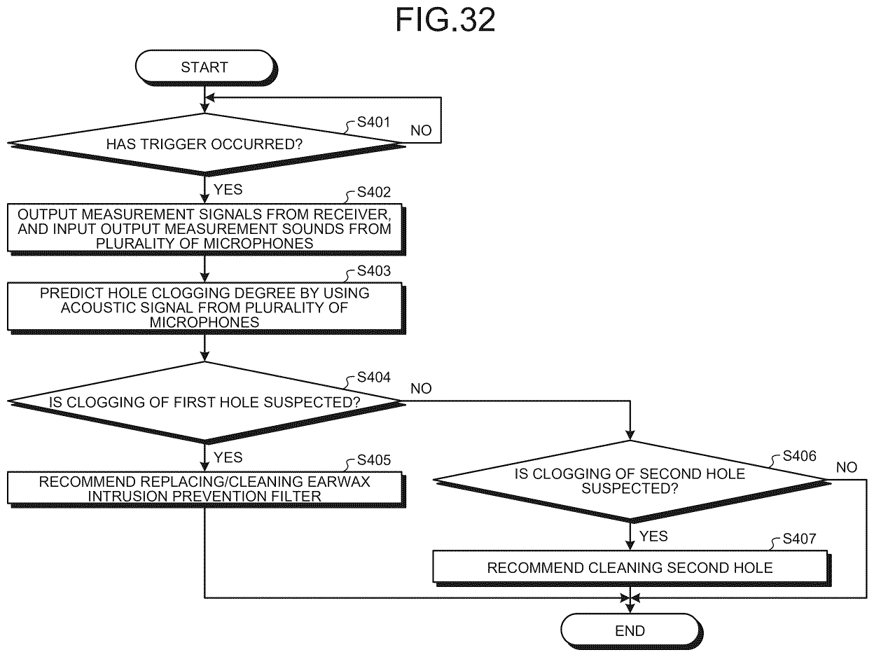

Next, an information processing method according to the embodiment will be described with reference to FIG. 32. FIG. 32 is a flowchart of the information processing method according to the embodiment. As illustrated in FIG. 32, the information processing method according to the embodiment includes a plurality of steps of Steps S401 to S407. Details of each step included in the information processing method according to the embodiment will be described below. Note that Step S401 of the embodiment is similar to Step S101 of the first embodiment in FIG. 11, and thus description thereof is omitted here.

The hearing aid 500 outputs measurement sounds from the receiver 501, and the output measurement sounds are input from the first microphone 504 and the second microphone 505 (Step S402). The hearing aid 500 predicts clogging of the earwax intrusion prevention filter 102 of the first hole 507 and clogging of the second hole 508 by using acoustic signals from the first microphone 504 and the second microphone 505 (Step S403).

The hearing aid 500 determines whether clogging of the earwax intrusion prevention filter 102 of the first hole 507 is suspected from the result of the clogging predicted in Step S403 above (Step S404). When clogging of the earwax intrusion prevention filter 102 of the first hole 507 is not suspected (Step S404: No), the hearing aid 500 proceeds to Step S406. In contrast, when clogging of the earwax intrusion prevention filter 102 of the first hole 507 is suspected (Step S404: Yes), the hearing aid 500 proceeds to Step S405. Then, the hearing aid 500 gives notification to recommend the user to replace or clean the earwax intrusion prevention filter 102 via, for example, the information processing terminal 400 (Step S405).

The hearing aid 500 determines whether clogging of the second hole 508 is suspected from the result of the clogging predicted in Step S403 above (Step S406). When clogging of the second hole 508 is not suspected (Step S406: No), the hearing aid 500 ends the processing. In contrast, when clogging of the second hole 508 is suspected (Step S406: Yes), the hearing aid 500 proceeds to Step S407. Then, the hearing aid 500 gives notification to recommend the user to clean the second hole 508 via, for example, the information processing terminal 400 and the charger 800 (Step S407).

As described above, according to the embodiment, clogging of the earwax intrusion prevention filter 102 of the first hole 507 and clogging of the second hole 508 can be easily and accurately detected.

### 11. Ninth Embodiment

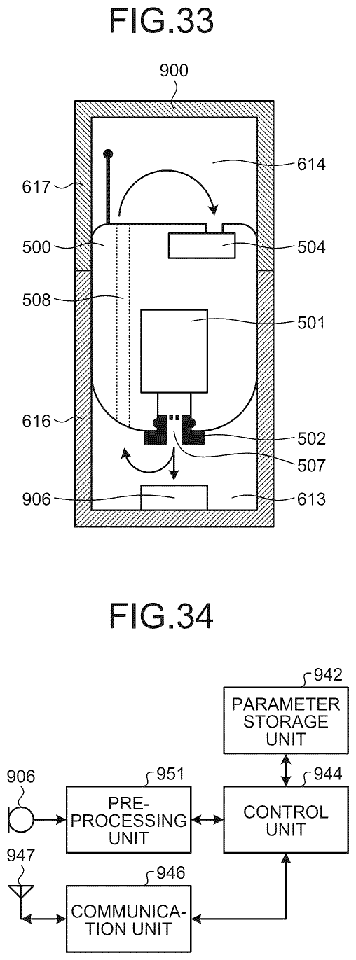

Next, a ninth embodiment of the present disclosure will be described with reference to FIGS. 33 and 34. The embodiment is different from the eighth embodiment in that a third microphone (third sound collection unit) is provided in the charger 800 or the like instead of the second microphone 505 provided in the hearing aid 500. Since a reduced number of microphones are mounted in the main body of the hearing aid 500, even an extremely small hearing aid 500 can achieve the embodiment. FIG. 33 is an explanatory diagram illustrating an example of application to the ear hole type hearing aid 500 according to the embodiment. FIG. 34 is a functional block diagram of a device on the side of a third microphone 906 according to the embodiment. Note that, although an example of the ear hole type hearing aid 500 is described here, the ear hanging type hearing aid 100 can also have a similar configuration in the embodiment.

As illustrated in FIG. 33, in the embodiment, the third microphone 906 is provided in the second closed space 613 and the third closed space 614 respectively defined by the second boundary 616 and the third boundary 617. The second closed space 613 and the third closed space 614 can store the hearing aid 500 as the charger 800 and the like. Note that a device provided with the third microphone 906 is referred to as a device 900 here. Then, the device 900 is not limited to the charger 800. The device 900 is not particularly limited as long as the device 900 is acoustically closed space that stores the hearing aid 500, that is, space that can inhibit sound transmission from the outside while storing the hearing aid 500.

Then, in the embodiment, the hearing aid 500 outputs a measurement sound for abnormality detection from the receiver 501. The measurement sound output from the receiver 501 is collected by the first microphone 504 via the second closed space 613, the second hole 508, and the third closed space 614. Furthermore, the measurement sound output from the receiver 501 is collected also by the third microphone 906 provided in the device 900. Moreover, in the embodiment, the measurement sounds collected by the first microphone 504 and the third microphone 906 are converted into acoustic signals, and used for abnormality detection.

FIG. 34 is a block diagram of functional units of the device 900 that can store the hearing aid 500, such as the charger 800. Note that the functional configuration of the hearing aid 500 is the same as the functional configuration of the hearing aid 500 of the eighth embodiment in FIG. 31, and thus description thereof is omitted here.

As illustrated in FIG. 34, the device 900 mainly includes a parameter storage unit 942, a control unit 944, a communication unit 946, and a preprocessing unit 951.

The third microphone 906 collects the measurement sound output from the receiver 501. The third microphone 906 converts the sound into an acoustic signal, and outputs the acoustic signal obtained by the conversion to the preprocessing unit 951. Then, the preprocessing unit 951 performs preprocessing as necessary by using the acoustic signal from the third microphone 906. Examples of the preprocessing include sampling rate conversion, frequency conversion, band division, level detection, standardization, and normalization. When performing the preprocessing, the preprocessing unit 951 can use a parameter stored in the parameter storage unit 942. In the embodiment, an amount of data to be transmitted to the side of the hearing aid 500 can be reduced by performing the preprocessing. Note that, in the embodiment, the preprocessing unit 951 is not required to be provided in the device 900. This enables a simpler configuration of the device 900.

Then, the control unit 944 transmits the signal received from the preprocessing unit 951 to the communication unit 946. The communication unit 946 can transmit the signal to the hearing aid 500 by using a communication antenna 947. The hearing aid 500 detects an abnormality by using the transmitted signal. Note that the embodiment is not limited to the configuration in FIG. 34. An abnormality detection unit may be provided on the side of the device 900, and the device 900 may detect an abnormality. The result may be transmitted to the hearing aid 500. Furthermore, in the information processing method according to the embodiment, for example, processing can be performed in accordance with the information processing method of the eighth embodiment in FIG. 32.

### 12. 10th Embodiment

### 12.1 Outline

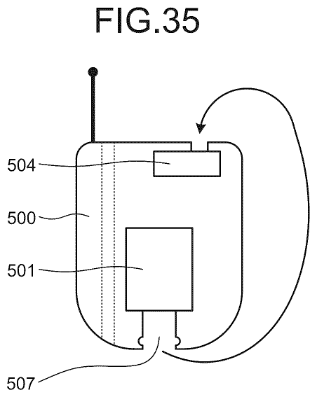

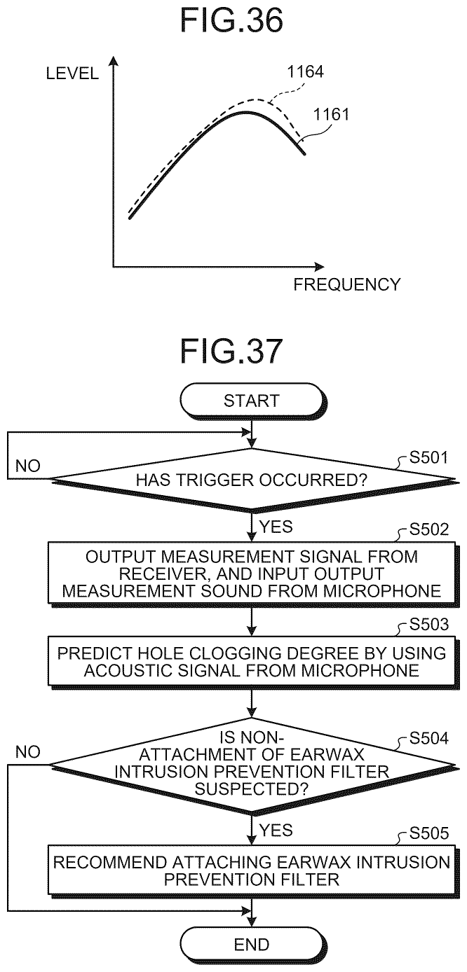

In a 10th embodiment of the present disclosure, non-attachment of the earwax intrusion prevention filter 502 of the first hole 507 is detected. The embodiment will be described with reference to FIGS. 35 and 36. FIG. 35 is an explanatory diagram illustrating an example of application to the ear hole type hearing aid 500 according to the embodiment. FIG. 36 is an explanatory diagram illustrating an example of the characteristics of a measurement sound collected in the embodiment. Note that, although an example of the ear hole type hearing aid 500 is described here, the ear hanging type hearing aid 100 can also have a similar configuration in the embodiment.

In the embodiment, as illustrated in FIG. 35, the hearing aid 500 outputs a measurement sound for abnormality detection from the receiver 501. The measurement sound output from the receiver 501 is collected by the first microphone 504 via the first hole 507. Then, the sound collected by the first microphone 504 is converted into an acoustic signal to be used for detecting an abnormality of the hearing aid 500, that is, detecting non-attachment of the earwax intrusion prevention filter 502.

FIG. 36 illustrates an example of the characteristics of a measurement sound collected by the first microphone 504 in the embodiment. Specifically, for example, a frequency characteristic in a case where the earwax intrusion prevention filter 502 is attached is the characteristic 1161. A frequency characteristic in a case where the earwax intrusion prevention filter 502 is not attached is a characteristic 1164. When the earwax intrusion prevention filter 502 is not attached, the acoustic resistance of the first hole 507 decreases. The level of the measurement sound collected by the first microphone 504 changes as in the characteristic 1164, for example. A difference between the characteristics of measurement sounds caused by the presence or absence of clogging of the earwax intrusion prevention filter 502 is clarified by analyzing the characteristics of the measurement sound collected in the states in which the earwax intrusion prevention filter 502 is attached/not attached by machine learning, statistical methods, and the like. Thus, in the embodiment, non-attachment of the earwax intrusion prevention filter 502 is detected by the difference between the characteristics of the measurement sounds collected by the first microphone 504.

### 12.2 Information Processing Method

Next, an information processing method according to the embodiment will be described with reference to FIG. 37. FIG. 37 is a flowchart of the information processing method according to the embodiment. As illustrated in FIG. 37, the information processing method according to the embodiment includes a plurality of steps of Steps S501 to S505. Details of each step included in the information processing method according to the embodiment will be described below. Note that Steps S501 to S503 of the embodiment are similar to Steps S101 to S103 of the first embodiment in FIG. 11, and thus description thereof is omitted here.

The hearing aid 500 determines whether non-attachment of the earwax intrusion prevention filter 502 is suspected from the result of the clogging predicted in Step S503 above (Step S504). When non-attachment of the earwax intrusion prevention filter 502 is not suspected (Step S504: No), the hearing aid 500 ends the processing. In contrast, when non-attachment of the earwax intrusion prevention filter 502 is suspected (Step S504: Yes), the hearing aid 500 proceeds to Step S505.

Then, the hearing aid 500 gives notification to recommend the user to attach the earwax intrusion prevention filter 502 to the user himself/herself (Step S505). For example, the hearing aid 500 may transmit information indicating that non-attachment of the earwax intrusion prevention filter 102 is suspected to the information processing terminal 400 and the like, and output, to the user, a voice message and a display massage, such as “Check whether the earwax intrusion prevention filter is attached. Would you like to display an attachment procedure?”.

As described above, according to the embodiment, non-attachment of the earwax intrusion prevention filter 102 can be easily and accurately detected.

### 13. 11th Embodiment

### 13.1 Outline

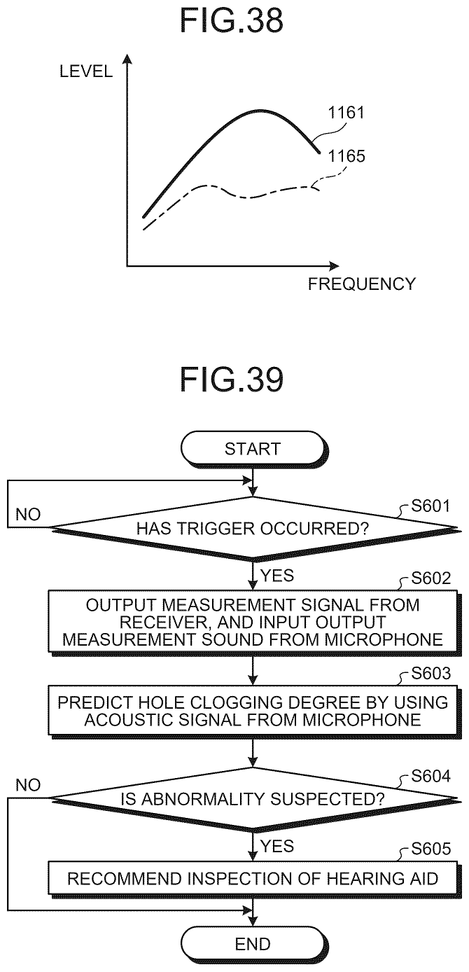

In an 11th embodiment of the present disclosure, an abnormality of the hearing aid 500 is detected. The embodiment will be described with reference to FIG. 38. FIG. 38 is an explanatory diagram illustrating an example of the characteristics of a measurement sound collected in the embodiment.

As illustrated in FIG. 38, for example, when the earwax intrusion prevention filter 502 is attached and the first hole 507 and the second hole 508 are not clogged, an acoustic signal collected by the first microphone 504 has a frequency characteristic of the characteristic 1161. In contrast, for example, even when the earwax intrusion prevention filter 502 is attached and the first hole 507 and the second hole 508 are not clogged, an acoustic signal collected by the first microphone 504 is considered to change to the frequency characteristic of a characteristic 1165 in a case where the hearing aid 500 itself has an abnormality. For example, when the hearing aid 500 is dropped on a hard floor, the receiver 501 and the first microphone 504 may fail. Furthermore, also when output of the receiver 501 significantly decreases or when the sensitivity of the first microphone 504 significantly decreases, a level of a measurement sound collected by the first microphone 504 may change as in the characteristic 1165, for example. Thus, in the embodiment, the failure of the hearing aid 500 is detected by the difference between the characteristics of the measurement sounds collected by the first microphone 504 as described above.

### 13.2 Information Processing Method

Next, an information processing method according to the embodiment will be described with reference to FIG. 39. FIG. 39 is a flowchart of the information processing method according to the embodiment. As illustrated in FIG. 39, the information processing method according to the embodiment includes a plurality of steps of Steps S601 to S605. Details of each step included in the information processing method according to the embodiment will be described below. Note that Steps S601 to S603 of the embodiment are similar to Steps S101 to S103 of the first embodiment in FIG. 11, and thus description thereof is omitted here.

The hearing aid 500 determines whether an abnormality of the hearing aid 500 is suspected from the result of the clogging predicted in Step S603 (Step S604). When an abnormality of the hearing aid 500 is not suspected (Step S604: No), the hearing aid 500 ends the processing. In contrast, when an abnormality of the hearing aid 500 is suspected (Step S604: Yes), the hearing aid 500 proceeds to Step S605. Then, the hearing aid 500 gives notification to recommend the user the user to request an inspection or repair from a support window (Step S605). For example, the hearing aid 500 may transmit information indicating that an abnormality of the hearing aid 500 is suspected to the information processing terminal 400, and output, to the user, a voice message and a display massage, such as “The hearing aid may fail to normally operate. Please contact a support center”. Moreover, the above-described information processing terminal 400 may output a message as described above, and may present a link to a contact destination.

As described above, according to the embodiment, an abnormality of the hearing aid 500 can be easily and accurately detected.

### 14. 12th Embodiment

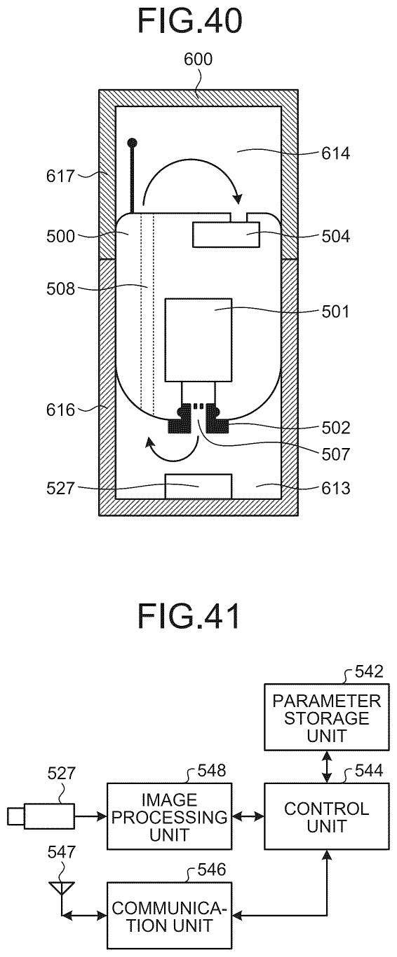

Next, a 12th embodiment of the present disclosure will be described with reference to FIGS. 40 and 41. In the embodiment, a camera (imaging unit) 527 is provided in the charger 800 or the like. The states of the first hole 507 and the second hole 508 are predicted by using information from the camera. According to the embodiment, the accuracy of abnormality detection can be enhanced by detecting an abnormality by using the information from the camera. FIG. 40 is an explanatory diagram illustrating an example of application to the ear hole type hearing aid 500 according to the embodiment. FIG. 41 is a functional block diagram of a device on the side of a camera 527 according to the embodiment. Note that, although an example of the ear hole type hearing aid 500 is described here, the ear hanging type hearing aid 100 can also have a similar configuration in the embodiment.

As illustrated in FIG. 40, in the embodiment, the camera 527 is provided in the second closed space 613 and the third closed space 614 respectively defined by the second boundary 616 and the third boundary 617. The second closed space 613 and the third closed space 614 can store the hearing aid 500 as the charger 800 and the like. Note that a device provided with the camera 527 is referred to as a device 600 here. Then, the device 600 is not limited to the charger 800. The device 600 is not particularly limited as long as the device 600 is acoustically closed space that stores the hearing aid 500, that is, space that can inhibit sound transmission from the outside while storing the hearing aid 500.

Specifically, in the embodiment, the hearing aid 500 outputs a measurement sound for abnormality detection from the receiver 501. The measurement sound output from the receiver 501 is collected by the first microphone 504 via the second closed space 613, the second hole 508, and the third closed space 614. In the embodiment, the measurement sound collected by the first microphone 504 is converted into an acoustic signal, and used for abnormality detection. Moreover, in the embodiment, the camera 527 captures images of the first hole 507 and the second hole 508. An image signal obtained by the image capturing is used for detecting an abnormality of the hearing aid 500 by an image recognition technique.

FIG. 41 is a block diagram of functional units of the device 600 that can store the hearing aid 500, such as the charger 800. Note that the functional configuration of the hearing aid 500 is the same as the functional configuration of the hearing aid 500 of the eighth embodiment in FIG. 31, and thus description thereof is omitted here.

As illustrated in FIG. 41, the device 600 mainly includes a parameter storage unit 542, a control unit 544, a communication unit 546, and an image processing unit 548.

Specifically, the camera 527 captures images of the states of the first hole 507 and the second hole 508, converts the images into image signals, and sends the image signals obtained by the conversion to the image processing unit 548. The image processing unit 548 can obtain, for example, an abnormality score value v (e.g., 0.0 to 1.0) indicating the states of clogging of the first hole 507 and the second hole 508 by using an image recognition technique. Furthermore, when performing image processing, the image processing unit 548 can use a parameter stored in the parameter storage unit 542.

Then, the control unit 544 transmits the abnormality score value v received from the image processing unit 548 to the communication unit 546. The communication unit 546 can transmit the abnormality score value v to, for example, the hearing aid 500 and the information processing terminal 400 by using a communication antenna 547. Then, the hearing aid 500 or the like detects an abnormality by using the transmitted abnormality score value v.

Here, an acoustic signal of the first microphone 504 is expressed by the sound quality change feature amount X1 and the short-time amplitude A1(t). Then, in the embodiment, for example, the abnormality detection unit 533 of the hearing aid 500 quantifies an abnormality degree based on the short-time amplitude A(t), the sound quality change feature amount X, and the above-described abnormality score value v. Specifically, the length y1 at which the sound quality change feature amount X exceeds a predetermined threshold, the maximum value y2 of the sound quality change feature amount X, the average value y3 of the sound quality change feature amount X, the maximum value y4 of the short-time amplitude A(t), and the average value y5 of the short-time amplitude A(t) are calculated, and used as feature vectors with the abnormality score value v being defined as y6. Then, the abnormality detection unit 533 calculates the value z indicating an abnormality degree in accordance with Expression (10) below.

$$Z = {\sum }_{i = 1}^{6} {u}_{i} {y}_{i} + {u}_{0} \qquad ( 10 )$$

Here, uᵢ is a load coefficient, and u₀ is a predetermined bias value. The load coefficient uᵢ and the bias value u₀ can be determined by using various statistical determination methods. For example, the degrees of clogging of a large number of types of first holes 507 and/or second holes 508 are preliminarily and subjectively evaluated. A learning sample is prepared by combining a feature vector and a desired score value (e.g., 0.0 to 1.0). Moreover, a load linearly approximated by multiple regression analysis on the learning sample can be obtained to determine the load coefficient uᵢ and the bias value u₀. Furthermore, in the embodiment, a neural network may be used instead of the multiple regression analysis. Determination methods such as the Bayesian estimation method and vector quantization may be used.

Furthermore, the information processing method according to the embodiments described so far can be used as the information processing method according to the embodiment, and thus description thereof is omitted here.

As described above, according to the embodiment, the accuracy of abnormality detection can be further enhanced by detecting an abnormality by using information from the camera 527. Note that, although the camera 527 has been described in an example here, for example, a time of flight (TOF) sensor, a depth sensor, and an IR sensor can be used as the camera 527 in addition to a visible light camera in the embodiment. For example, the TOF sensor, the depth sensor, and the IR sensor may detect the states of the first hole 507 and the second hole 508.

### 15. 13th Embodiment

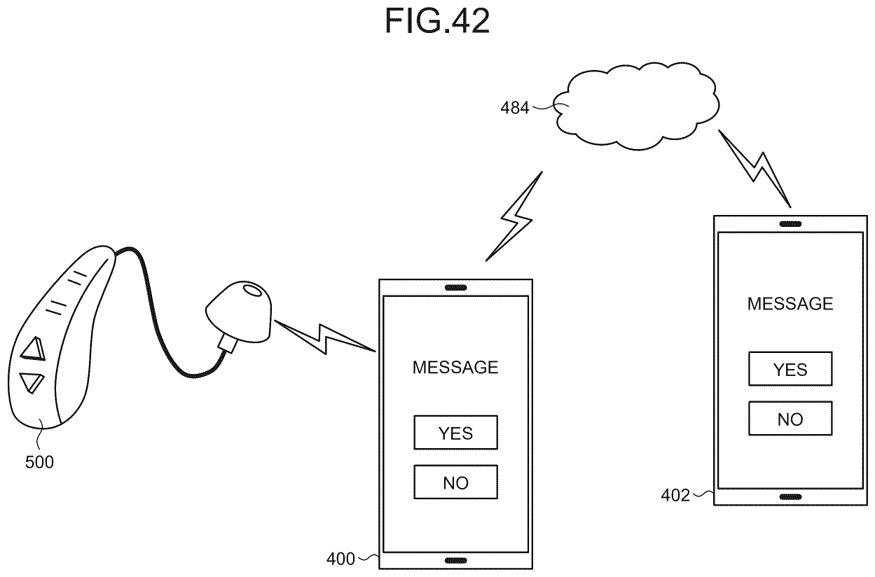

Although, in the embodiment of the present disclosure described above, an example in which abnormality notification is given by using the hearing aid 500 and the information processing terminal 400 of the user has been mainly described, the present disclosure is not limited thereto. Thus, a 13th embodiment of the present disclosure in which notification is given by using another information processing terminal will be described with reference to FIG. 42. FIG. 42 illustrates a schematic configuration of the hearing aid system 1 according to the embodiment.

As illustrated in FIG. 42, in the embodiment, the hearing aid 500 notifies the information processing terminal 400 of a result of abnormality detection. Alternatively, in the embodiment, the information processing terminal 400 may be notified not directly from the hearing aid 500 but, for example, via the charger 800 or the like. Moreover, in the embodiment, the information processing terminal 400 may transmit a notification to another preliminarily registered information processing terminal 402 via a communication network 484 or a communication path (not illustrated). Alternatively, in the embodiment, a notification may be transmitted from the hearing aid 500 to the information processing terminal 402 via the communication network 484 or the like. In the embodiment, the information processing terminal 400 is assumed to be possessed by the user of the hearing aid 500. The information processing terminal 402 is assumed to be possessed by a support provider such as a family of the user and a caregiver. An elderly user of the hearing aid 500 may fail to address abnormality detection notification by himself/herself. In the embodiment, a notification reaches the information processing terminal 402 of a family or a caregiver, so that a quick and reliable response to the abnormality notification can be expected. That is, according to the embodiment, the user and his/her family are notified of a result of a detected abnormality. Such a problem that the user of the hearing aid 500 continues to hear inappropriate sounds can thereby be expected to be promptly solved.

Note that, in the embodiment, when notification is given from the information processing terminal 400 to the information processing terminal 402, the approval for the notification may be confirmed with the user of the hearing aid 500. Alternatively, the approval may be omitted by preliminarily setting an operation at the time of notification.

### 16. 14th Embodiment

### 16.1 Outline

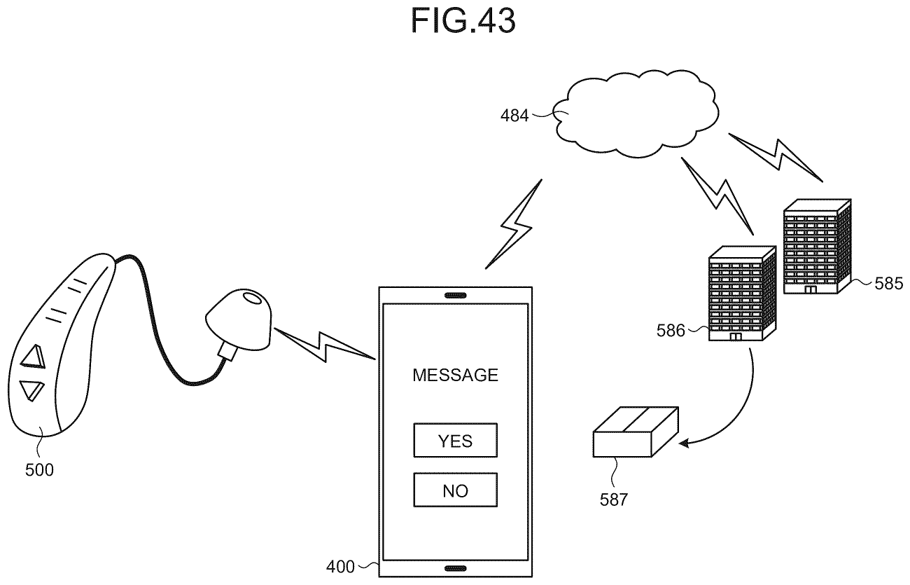

In a 14th embodiment of the present disclosure, a purchase system in which a product such as a consumable of a hearing aid can be easily obtained is proposed. The embodiment will be described with reference to FIG. 43. FIG. 43 illustrates a schematic configuration of a hearing aid system 1a according to the embodiment.

In the embodiment, as illustrated in FIG. 43, the hearing aid 500 notifies the information processing terminal 400 of a result of abnormality detection. Then, the information processing terminal 400 transmits a notification to a server of a preliminarily registered sales company 586 via the communication network 484 and a communication path (not illustrated). Note that, although, in the example of FIG. 43, notification is given from the information processing terminal 400 to the server of the sales company 586, the embodiment is not limited thereto. The notification may be given directly from the hearing aid 500 to the sales company 586. Note that, when the sales company 586 is notified, the approval for the notification may be confirmed with the user of the hearing aid 500. Alternatively, the approval may be omitted by preliminarily setting an operation at the time of notification. Furthermore, when confirming the approval for notification with the user, the information processing terminal 400 may display a message such as “Would you like to purchase an earwax intrusion prevention filter?” and “Would you like to purchase a vent cleaning brush?”, and confirm the presence or absence of the approval for the notification based on the reply from the user.

Then, the sales company 586 that has received the notification sends, to the user, a purchased product 587 such as the earwax intrusion prevention filter 502 adapted to the hearing aid 500. In the embodiment, in order to identify a consumable and the like such as the earwax intrusion prevention filter 502 adapted to the hearing aid 500, the information processing terminal 400 may transmit, to the sales company 586, information for identifying the user and the hearing aid 500 used by the user and information for identifying the consumable. According to the embodiment, this enables the sales company 586 to send the purchased product 587 without delay, so that the purchased product 587 is expected to be quickly obtained.

Furthermore, as illustrated in FIG. 43, in the embodiment, when providing support service, a support service provider 585 may use an abnormality detection result of the hearing aid 500 as reference information. Specifically, the hearing aid 500 notifies the information processing terminal 400 of a result of abnormality detection. Then, the information processing terminal 400 may transmit a notification to a server of the preliminarily registered support service provider 585 via the communication network 484 and a communication path (not illustrated). Note that, although, in the example of FIG. 43, notification is given from the information processing terminal 400 to the server of the support service provider 585, the embodiment is not limited thereto. The notification may be given directly from the hearing aid 500 to the support service provider 585. Note that, when the support service provider 585 is notified, the approval for the notification may be confirmed with the user of the hearing aid 500. Alternatively, the approval may be omitted by preliminarily setting an operation at the time of notification. Furthermore, when confirming the approval for notification with the user, the information processing terminal 400 may display a message such as “Do you approve transmission of a result of abnormality detection to the support service provider?”, and confirm the presence or absence of the approval for the notification based on the reply from the user.

Then, in the embodiment, the support service provider 585 that has received the notification can use information on the abnormality detection result when providing support service. Examples of the support service include an inquiry regarding trouble of the hearing aid 500 from the user of the hearing aid 500. It can be expected that, when an inquiry regarding such trouble that no sound is made, the support service provider 585 can quickly address the inquiry since the support service provider 585 holds information on the abnormality detection result. Moreover, before receiving an inquiry from the user, the support service provider 585 can inquire of the user the state of the hearing aid 500, and provide support service more actively.

As described above, according to the embodiment, the sales company 586 and the support service company 585 are notified of a result of a detected abnormality. Such a problem that the user of the hearing aid continues to hear inappropriate sounds can be expected to be promptly solved.

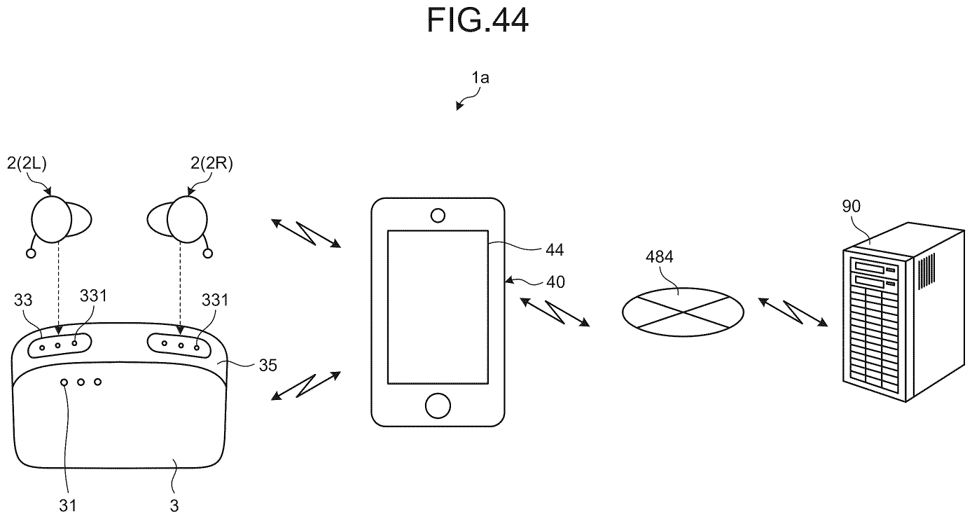

For example, the hearing aid system 1a according to the embodiment in FIG. 44 can achieve the embodiment. FIG. 44 illustrates a schematic configuration of the hearing aid system 1a according to the embodiment. As illustrated in FIG. 44, the hearing aid system 1a according to the embodiment includes a pair of right and left hearing aids 2, the charger 3 (charging case), and the information processing terminal 40 such as a smartphone. The charger 3 houses the hearing aids 2, and charges the hearing aids 2. The information processing terminal 40 can communicate with at least one of the hearing aids 2 and the charger 3. Moreover, the hearing aid system 1a according to the embodiment includes a server (information processing server) 90 managed by the sales company 586 or the support service provider 585.

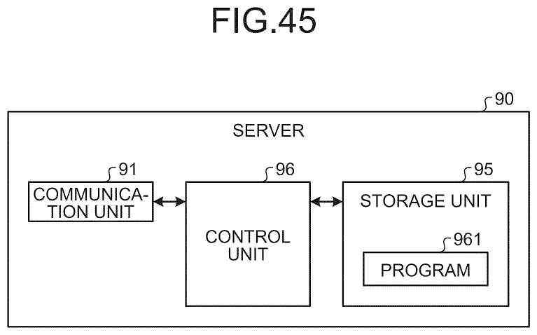

Moreover, the server 90 may be configured as illustrated in FIG. 45. FIG. 45 is a block diagram of the server 90 according to the embodiment. As illustrated in FIG. 45, the server 90 mainly includes a communication unit 91, a storage unit 95, and a control unit 96.

The communication unit 91 communicates with the hearing aid 2 or the information processing terminal 40 via the communication network 484 under the control of the control unit 96. The communication unit 91 can include, for example, a communication module. Furthermore, the storage unit 95 stores various types of information on the hearing aid 500. Moreover, the storage unit 95 stores various programs 961 and the like to be executed by the server 90. The storage unit 95 can include, for example, a recording medium such as a RAM, a ROM, a flash memory, and a memory card.

The control unit 96 controls each unit constituting the server 90. The control unit 96 can include, for example, a memory and a processor having hardware such as a CPU. The control unit 96 reads and executes a program stored in the storage unit 95 in a work area of the memory, and controls each component and the like through execution of the program performed by the processor.

### 17. Conclusion

As described above, according to the embodiments of the present disclosure, an abnormality of the hearing aids 100 and 500 can be easily and accurately detected. Specifically, according to the embodiments of the present disclosure, clogging of the first hole 107 and the earwax intrusion prevention filter 102, clogging of the second hole 108, non-attachment of the earwax intrusion prevention filter 102, an abnormality of the receiver 101, an abnormality of the microphone 104, and the like can be easily and accurately detected.

Note that, although the embodiments of the present disclosure have been described as being applied to the hearing aids 100 and 500, the embodiments of the present disclosure can be applied to any device having a hearing aid function and a structure in which an abnormality may occur in a hole. Examples of such a device include earphones, headsets, and a sound collector.

### 18. Example of Data Utilization

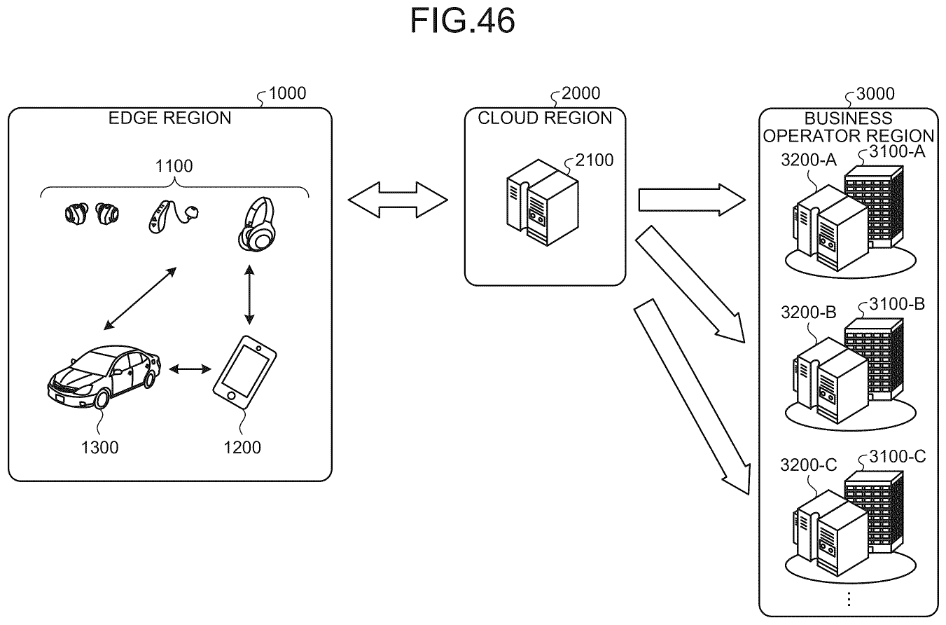

Moreover, the data obtained in connection with use of the hearing aids 100 and 500 may be variously utilized. An example will be described with reference to FIG. 46.

FIG. 46 illustrates an example of data utilization. In an illustrated system, there are an edge region 1000, a cloud region 2000, and a business operator region 3000. Sound production devices 1100, a peripheral device 1200, and a vehicle 1300 are illustrated as elements in the edge region 1000. A server device 2100 is illustrated as an element in the cloud region 2000. Business operators 3100 and server devices 3200 are illustrated as elements in the business operator region 3000.

The sound production devices 1100 in the edge region 1000 are used by being attached to the user or arranged near the user so as to produce a sound toward the user. Specific examples of the sound production devices 1100 include earphones, headsets (headphones), and hearing aids. More specifically, the sound production devices 1100 can be the hearing aids 2 and 100 described with reference to FIGS. 1 and 4 and the like.

The peripheral device 1200 and the vehicle 1300 in the edge region 1000 are devices used together with the sound production devices 1100, and transmit signals such as a content listening sound, a call sound, and a warning sound to the sound production devices 1100. The sound production devices 1100 output sounds in accordance with signals from the peripheral device 1200 and the vehicle 1300 to the user. Specific examples of the peripheral device 1200 include a smartphone. For example, an external device 70 described above with reference to FIG. 13 and the like may be used as the peripheral device 1200.

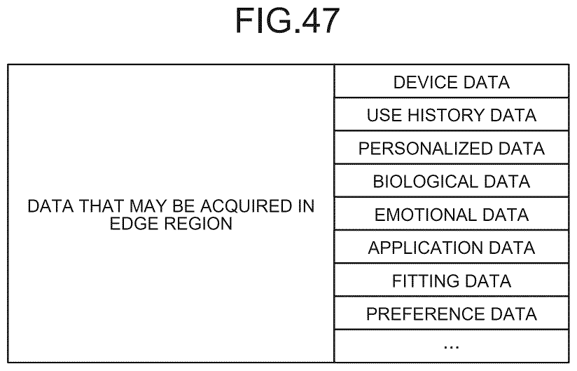

Various types of data on use of the sound production devices 1100 may be acquired in the edge region 1000. Description will be given with reference to FIG. 47.

FIG. 47 illustrates an example of data. Examples of the data that may be acquired in the edge region 1000 include device data, use history data, personalized data, biological data, emotional data, application data, fitting data, and preference data. Note that the data may be understood as meaning of information. Data and information may be appropriately replaced with each other as long as there is no contradiction. Various known methods may be used to acquire the illustrated data.

The device data relates to a sound production device 1100. For example, the device data includes type data on the sound production device 1100, specifically, data for identifying the sound production device 1100 as earphones, headphones, a true wireless stereo (TWS), or hearing aids (e.g., CIC, ITE, and RIC).

The use history data relates to the sound production device 1100. Examples of the use history data include data on a music exposure level, a continuous use time of a hearing aid, and a content listening history (e.g., listening time). The use history data can be used for safe listening, causing a TWS to function as a hearing aid, notification regarding replacement of the earwax intrusion prevention filter 102, and the like.

The personalized data relates to the user of the sound production device 1100. Examples of the personalized data include a head related transfer function (HRTF), ear canal characteristics, and the type of earwax of an individual user. Moreover, the personalized data also includes data on hearing and the like.

The biological data relates to the user of the sound production device 1100. Examples of the biological data include data on perspiration, blood pressure, blood flow, heart rate, pulse, body temperature, brain waves, respiration, and myoelectric potential.

The emotional data indicates the emotion of the user of the sound production device 1100. Examples of the emotional data include data indicating comfort, discomfort, and the like.

The application data is used in various applications. Examples of the application data include user attribute information data, such as the position of the user of the sound production device 1100 (which may be position of sound production device 1100), a schedule, age, and gender, and data on weather, atmospheric pressure, temperature, and the like. For example, position data can be used to search for a lost sound production device 1100 and to determine the timing when clogging of the earwax intrusion prevention filter 102 is predicted.

Examples of the fitting data can include an adjustment parameter of the hearing aid 2 used by the user and a hearing aid gain for each frequency band set based on a measurement result (audiogram) of the hearing of the user.

The preference data relates to the preference of the user. Examples of the preference data include the preference of music heard at the time of driving.

Note that, for example, data on a communication situation and data on a charging situation of the sound production device 1100 and the like may also be acquired. A part of the processing in the edge region 1000 may be executed in the cloud region 2000 in accordance with a band, a communication situation, a charging situation, and the like. A processing load in the edge region 1000 is reduced by sharing the processing.

Returning to FIG. 46, for example, data as described above is acquired in the edge region 1000, and transmitted from the sound production device 1100, the peripheral device 1200, or the vehicle 1300 to the server device 2100 in the cloud region 2000. The server device 2100 stores (e.g., saves and accumulates) the received data.

The business operators 3100 in the business operator region 3000 use the server devices 3200 to acquire data from the server device 2100 in the cloud region 2000. The business operators 3100 can utilize data.

There may be various business operators 3100. Specific examples of the business operators 3100 include a hearing aid shop, a hearing aid manufacturer, a content production company, and a distributor that provides music streaming service. In order to distinguish the business operators 3100 from each other, the business operators 3100 are referred to and illustrated as a business operator 3100-A, a business operator 3100-B, and a business operator 3100-C. The corresponding server devices 3200 are referred to and illustrated as a server device 3200-A, a server device 3200-B, and a server device 3200-C. Various types of data are provided to such various business operators 3100, and data utilization is promoted. Data may be provided to the business operators 3100 by, for example, subscription and recurring.

Data can also be provided from the cloud region 2000 to the edge region 1000. For example, when machine learning is necessary for performing processing in the edge region 1000, data for, for example, feeding back and revising learning data is prepared by an administrator and the like of the server device 2100 in the cloud region 2000. The prepared data is transmitted from the server device 2100 to the sound production devices 1100, the peripheral device 1200, or the vehicle 1300 in the edge region 1000.

When a specific condition is satisfied in the edge region 1000, some incentive (benefit such as premium service) may be provided to the user. Examples of the condition include a condition that at least some devices of the sound production devices 1100, the peripheral device 1200, and the vehicle 1300 are provided by the same business operator. An incentive capable of being electronically supplied (e.g., electronic coupon) may be transmitted from the server device 2100 to the sound production device 1100, the peripheral device 1200, or the vehicle 1300.

### 19. Example of Cooperation with Another Device

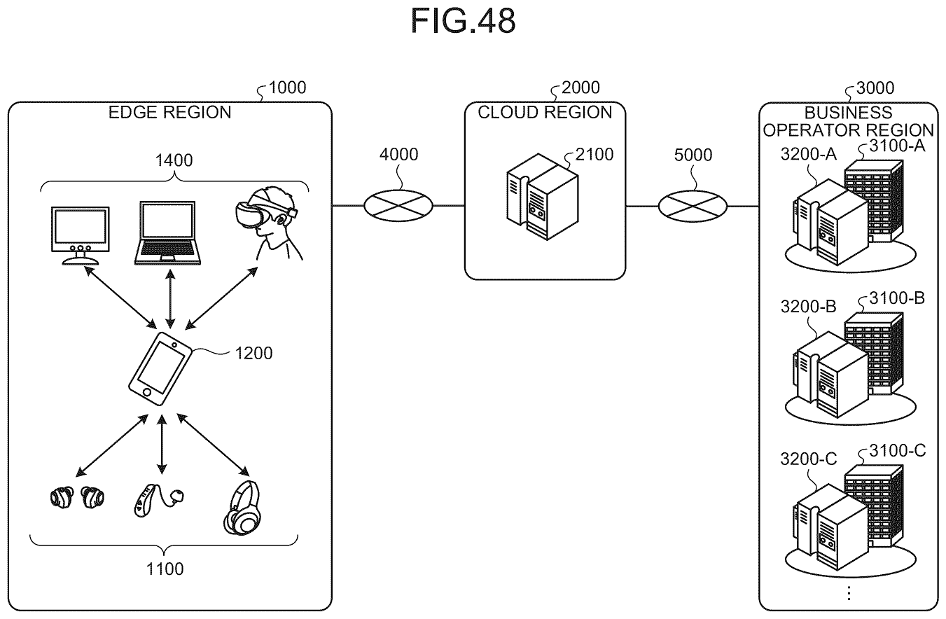

In the edge region 1000, the sound production device 1100 may cooperate with another device by using the peripheral device 1200 such as a smartphone as a hub. An example will be described with reference to FIG. 48.

FIG. 48 illustrates an example of cooperation with another device. The edge region 1000, the cloud region 2000, and the business operator region 3000 are connected by a network 4000 and a network 5000. A smartphone is illustrated as a peripheral device 1200 in the edge region 1000. Furthermore, other devices 1400 are also illustrated as elements in the edge region 1000. Note that the vehicle 1300 (FIG. 46) is not illustrated.

The peripheral device 1200 can communicate with the sound production devices 1100 and the other devices 1400. A communication method is not particularly limited. For example, Bluetooth LDAC and the above-described Bluetooth LE Audio, and the like may be used. The peripheral device 1200 may communicate with the other devices 1400 by multicast communication. Examples of the multicast communication include Auracast (registered trademark).

The other devices 1400 are used in cooperation with the sound production devices 1100 via the peripheral device 1200. Specific examples of the other devices 1400 include a television (hereinafter, referred to as TV), a personal computer (PC), a head mounted display (HMD), a robot, a smart speaker, and a gaming device.

Also when the sound production devices 1100, the peripheral device 1200, and the other devices 1400 satisfy a specific condition (e.g., condition that at least some of the devices are provided by the same business operator), an incentive may be provided to the user.

The sound production devices 1100 and the other devices 1400 can cooperate with each other by using the peripheral device 1200 as a hub. The cooperation may be performed by using various types of data stored in the server device 2100 in the cloud region 2000. For example, information of fitting data, a listening time, hearing, and the like of the user is shared between the sound production devices 1100 and the other devices 1400. The volumes of the devices are thus adjusted in cooperation. When the hearing aid 2 (HA) and a sound collector (personal sound amplification product (PSAP)) are attached, settings for the hearing aid 2 and the PSAP can be automatically made by a TV, a PC, and the like. For example, when the user using the hearing aid 2 uses another device such as a TV and a PC, processing of changing the setting of the other device may be automatically performed so that a usual setting for a person with normal hearing is changed to a setting suitable for the user using the hearing aid. Note that whether the user is using the hearing aid 2 may be determined at the time when the hearing aid 2 is attached to the user by information that the hearing aid 2 has been attached (e.g., attachment detection information) being automatically sent to equipment, such as a TV and a PC, of a pairing destination of the hearing aid 2, or may be detected by using, as a trigger, approach of the user using the hearing aid to another target device such as a TV and a PC. Furthermore, a user may be determined as using the hearing aid by imaging a face of the user with a camera and the like provided in another device such as a TV and a PC, or may be determined by a method other than the above-described methods. Furthermore, the hearing aid 2 can function as an earphone by cooperation between the hearing aid 2, which is a sound production device 1100, and the other devices 1400. Moreover, when the other devices 1400 include a microphone that collects an ambient sound, an earphone, which is a sound production device 1100, can function as the hearing aid 2. In this case, the function of the hearing aid can be used in a style (e.g., appearance) as if music is heard. Earphones/headphones and hearing aids have many technically overlapping parts. It is assumed that a barrier therebetween disappears in the future and one device has functions of both earphones and hearing aids. When having normal hearing, that is, a person with normal hearing can enjoy a content listening experience by using one device as usual earphones/headphones. When the hearing of the person is lowered with age, the device can function as hearing aids by turning on the hearing aid function. Since a device serving as earphones can be used as hearing aids as it is, continuous and long-term use of the user can be expected also from the viewpoints of appearance and design.

Data on a listening history of the user may be shared. Prolonged listening can be a risk of future hearing loss. The user may be notified to avoid having an excessively long listening time. For example, when a listening time exceeds a predetermined threshold, notification is given as described above (safe listening). Any device in the edge region 1000 may give the notification.

At least some of devices used in the edge region 1000 may be provided by different business operators. Information on a device setting of each business operator and the like may be transmitted from the server devices 3200 of the business operator region 3000 to the server device 2100 of the cloud region 2000, and stored in the server device 2100. Cooperation between the devices provided by different business operators is made possible by using such information.

### 20. Example of Application Transition

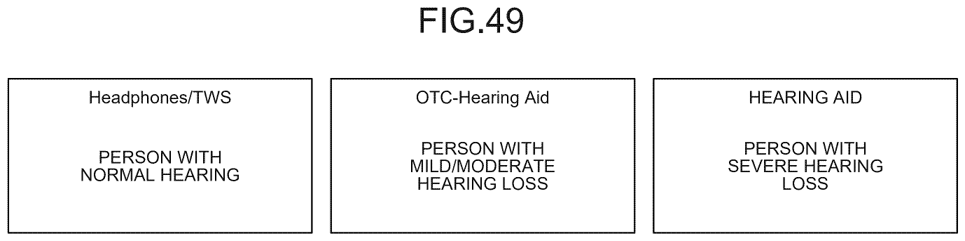

The application of a sound production device 1100 may transition in accordance with various situations of fitting data, a listening time, hearing, and the like of the user as illustrated above. An example will be described with reference to FIG. 49.

FIG. 49 illustrates an example of application transition. When the user has normal hearing, for example, while the user is a child and for a while after the user becomes an adult, a sound production device 1100 is used as headphones and earphones (or TWS). In addition to the safe listening described above, adjustment of an equalizer and processing in accordance with the behavior characteristics and the current location of the user and an external environment (e.g., switching between noise canceling mode optimum for scene in which user is in restaurant and noise canceling mode optimum for scene in which user is on vehicle) are performed. Listening music piece logs are also collected, for example. Communication between devices using Auracast is also used.

When the hearing of the user decreases, the hearing aid function of the sound production device 1100 starts to be used. For example, while the user has mild/moderate hearing loss, the sound production device 1100 is used as an over the counter hearing aid (OTC hearing aid). When the user has severe hearing loss, the sound production device 1100 is used as hearing aids. Note that the OTC hearing aid is sold at a shop without an expert, and can be easily purchased without a hearing test and an expert such as an audiologist. The user himself/herself may perform an operation peculiar to a hearing aid, such as fitting. While the sound production device 1100 is used as OCT hearing aids and hearing aids, hearing is measured, and the hearing aid function is turned on. For example, a function of transmitting an utterance flag in the above-described embodiments may be used. Furthermore, various types of information on hearing (hearing big data) are collected. Fitting, sound environment adaptation, remote support, and the like are performed. Transcription is further performed.

### 21. Supplements

Although the preferred embodiments of the present disclosure have been described in detail with reference to the accompanying drawings, the technical scope of the present disclosure is not limited to such examples. It is obvious that a person having ordinary knowledge in the technical field of the present disclosure can conceive various changes or modifications within the scope of the technical idea described in claims, and it is naturally understood that these changes or modifications also belong to the technical scope of the present disclosure.

Furthermore, the effects described in the present specification are merely illustrative or exemplary ones, and are not limitations. That is, the technique according to the present disclosure can exhibit other effects obvious to those skilled in the art from the description of the present specification together with or instead of the above-described effects.

Note that the present technique can also have the configurations as follows.
(1) An information processing apparatus capable of being at least partially attached to an ear canal of a user, comprising:
   an output unit that outputs a measurement sound for detecting an abnormality of the information processing apparatus;
   a first sound collection unit that collects the measurement sound; and
   an abnormality detection unit that detects the abnormality based on an acoustic signal collected by the first sound collection unit.
(2) The information processing apparatus according to (1), wherein the output unit outputs the measurement sound in a state in which the information processing apparatus is not attached to an ear canal of the user.
(3) The information processing apparatus according to (2), wherein the output unit outputs the measurement sound in a state in which the information processing apparatus is stored in acoustically closed space.
(4) The information processing apparatus according to any one of (1) to (3), wherein the abnormality detection unit predicts the abnormality by using a model obtained by machine learning.
(5) The information processing apparatus according to any one of (1) to (3),
   wherein the abnormality detection unit includes:
   an analysis unit that analyzes an acoustic signal collected by the first sound collection unit; and
   a determination unit that determines presence or absence of the abnormality based on an analysis result.
(6) The information processing apparatus according to any one of (1) to (5), further comprising a notification unit that notifies the user of the abnormality when the abnormality is detected.
(7) The information processing apparatus according to any one of (1) to (6), further comprising
   a housing portion that incorporates the first sound collection unit,
   wherein the housing portion has a first hole that causes the output unit and an ear canal of the user to communicate with each other, and
   the first sound collection unit is provided at a position away from an opening of the first hole by a predetermined distance, and collects the measurement sound that has passed through the first hole.
(8) The information processing apparatus according to any one of (1) to (6), and further comprising
   an attachment part capable of being attached to an ear canal of the user and having a first hole that causes the output unit and the ear canal of the user to communicate with each other,
   wherein the output unit is attached to an ear canal of the user via the attachment part, and
   the first sound collection unit is attached to an auricle of the user, and collects the measurement sound that has passed through the first hole.
(9) The information processing apparatus according to (7) or (8), further comprising
   a second hole that causes an inner region and an outer region of an ear canal of the user, which are separated from the information processing apparatus, to communicate with each other when the information processing apparatus is attached to the ear canal,
   wherein the first sound collection unit collects the measurement sound that has passed through the first hole and the second hole.
(10) The information processing apparatus according to (9), wherein the abnormality detection unit detects at least one of an abnormality of the first hole, an abnormality of the second hole, an abnormality of a filter attached to the first hole, an abnormality of the output unit, and an abnormality of the first sound collection unit.
(11) The information processing apparatus according to any one of (1) to (10), further comprising:
   a communication unit capable of communicating with an external device including at least one of a charger, an information processing terminal, and an information processing server; and
   an activation signal detection unit that detects an activation signal from the external device and activates the output unit.
(12) The information processing apparatus according to any one of (1) to (11), further comprising
   a second sound collection unit that is provided adjacent to the output unit and that collects the measurement sound,
   wherein the abnormality detection unit detects the abnormality based on an acoustic signal collected by the second sound collection unit.
(13) The information processing apparatus according to any one of (1) to (12),
   wherein the information processing apparatus is a hearing aid.
(14) The information processing apparatus according to any one of (1) to (12),
   wherein the information processing apparatus is an earphone.
(15) An information processing system comprising:
   an information processing apparatus capable of being at least partially attached to an ear canal of a user; and
   a charger of the information processing apparatus,
   wherein the information processing apparatus includes:
   an output unit that outputs a measurement sound for detecting an abnormality of the information processing apparatus;
   a first sound collection unit that collects the measurement sound; and
   an abnormality detection unit that detects the abnormality based on an acoustic signal collected by the first sound collection unit.
(16) The information processing system according to (15), wherein the charger is configured as acoustically closed space capable of storing the information processing apparatus.
(17) The information processing system according to (16), wherein the charger further includes a fixing portion that internally fixes the information processing apparatus.
(18) The information processing system according to (16) or (17), wherein the charger further includes a third sound collection unit that collects the measurement sound.
(19) The information processing system according to any one of (15) to (18),
   wherein the charger further includes an imaging unit that images the information processing apparatus that has been stored, and
   the abnormality detection unit detects the abnormality based on an image captured by the imaging unit.
(20) The information processing system according to any one of (15) to (19), further comprising an information processing terminal capable of communicating with the information processing apparatus.
(21) The information processing system according to any one of (15) to (20), further comprising an information processing server capable of communicating with the information processing apparatus.
(22) An information processing method of detecting an abnormality of an information processing apparatus capable of being at least partially attached to an ear canal of a user, comprising:
   by the information processing apparatus, outputting a measurement sound for detecting an abnormality of the information processing apparatus;
   collecting the measurement sound; and
   detecting the abnormality based on an acoustic signal that has been collected.

### REFERENCE SIGNS LIST

1, 1a HEARING AID SYSTEM
2, 100, 500 HEARING AID
3, 800 CHARGER
20b, 20f SOUND COLLECTION UNIT
21 SIGNAL PROCESSING UNIT
22 OUTPUT UNIT
25, 32 BATTERY
26, 331 CONNECTION UNIT
27, 30, 34, 42, 91, 136, 536, 546, 846, 946 COMMUNICATION UNIT
28, 35, 45, 95 STORAGE UNIT
29, 36, 46, 96, 134, 534, 544, 844, 944 CONTROL UNIT
31, 44, 822 DISPLAY UNIT
33 HOUSING UNIT
40, 400, 402 INFORMATION PROCESSING TERMINAL
41 INPUT UNIT
43 OUTPUT UNIT
70 EXTERNAL DEVICE
90 SERVER
101, 222, 501 RECEIVER
102, 502 EARWAX INTRUSION PREVENTION FILTER
103 EAR TIP
104, 504 FIRST MICROPHONE
107, 507 FIRST HOLE
108, 508 SECOND HOLE
131, 531 MEASUREMENT SIGNAL REPRODUCTION UNIT
132, 532, 542, 942 PARAMETER STORAGE UNIT
133, 533 ABNORMALITY DETECTION UNIT
135, 535 TRIGGER DETECTION UNIT
137, 547, 847, 947 COMMUNICATION ANTENNA
151, 951 PREPROCESSING UNIT
152 ANALYSIS UNIT
153 DETERMINATION UNIT
201b, 201f MICROPHONE
202b, 202f A/D CONVERSION UNIT
221 D/A CONVERSION UNIT
281, 351 PROGRAM
282 DATA
484 COMMUNICATION NETWORK
505 SECOND MICROPHONE
509 STRING
527 CAMERA
548 IMAGE PROCESSING UNIT
586 SALES COMPANY
587 PURCHASED PRODUCT
600, 900 DEVICE
612 FIRST CLOSED SPACE
613 SECOND CLOSED SPACE
614 THIRD CLOSED SPACE
615 FIRST BOUNDARY
616 SECOND BOUNDARY
617 THIRD BOUNDARY
618 FOURTH BOUNDARY
711 SPACE
791 EAR CANAL OUTSIDE
792 EAR CANAL INSIDE
823, 872, 873, 874, 875, 885, 886, 891, 892 BUTTON
845 TRIGGER DETECTION UNIT
871, 882, 971 MESSAGE
883, 884 DISPLAY SCREEN
887 RADIO BUTTON
889 SLIDER BAR
890 SWITCH
906 THIRD MICROPHONE
924 FIXING PORTION
1161, 1162, 1163, 1164, 1165 CHARACTERISTICS

1. An information processing apparatus capable of being at least partially attached to an ear canal of a user, comprising:
an output unit that outputs a measurement sound for detecting an abnormality of the information processing apparatus;
a first sound collection unit that collects the measurement sound; and
an abnormality detection unit that detects the abnormality based on an acoustic signal collected by the first sound collection unit.

2. The information processing apparatus according to claim 1, wherein the output unit outputs the measurement sound in a state in which the information processing apparatus is not attached to an ear canal of the user.

3. The information processing apparatus according to claim 2, wherein the output unit outputs the measurement sound in a state in which the information processing apparatus is stored in acoustically closed space.

4. The information processing apparatus according to claim 1, wherein the abnormality detection unit predicts the abnormality by using a model obtained by machine learning.

5. The information processing apparatus according to claim 1,
wherein the abnormality detection unit includes:
an analysis unit that analyzes an acoustic signal collected by the first sound collection unit; and
a determination unit that determines presence or absence of the abnormality based on an analysis result.

6. The information processing apparatus according to claim 1, further comprising a notification unit that notifies the user of the abnormality when the abnormality is detected.

7. The information processing apparatus according to claim 1, further comprising
a housing portion that incorporates the first sound collection unit,
wherein the housing portion has a first hole that causes the output unit and an ear canal of the user to communicate with each other, and
the first sound collection unit is provided at a position away from an opening of the first hole by a predetermined distance, and collects the measurement sound that has passed through the first hole.

8. The information processing apparatus according to claim 1, and further comprising
an attachment part capable of being attached to an ear canal of the user and having a first hole that causes the output unit and the ear canal of the user to communicate with each other,
wherein the output unit is attached to an ear canal of the user via the attachment part, and
the first sound collection unit is attached to an auricle of the user, and collects the measurement sound that has passed through the first hole.

9. The information processing apparatus according to claim 7, further comprising
a second hole that causes an inner region and an outer region of an ear canal of the user, which are separated from the information processing apparatus, to communicate with each other when the information processing apparatus is attached to the ear canal,
wherein the first sound collection unit collects the measurement sound that has passed through the first hole and the second hole.

10. The information processing apparatus according to claim 9, wherein the abnormality detection unit detects at least one of an abnormality of the first hole, an abnormality of the second hole, an abnormality of a filter attached to the first hole, an abnormality of the output unit, and an abnormality of the first sound collection unit.

11. The information processing apparatus according to claim 1, further comprising:
a communication unit capable of communicating with an external device including at least one of a charger, an information processing terminal, and an information processing server; and
an activation signal detection unit that detects an activation signal from the external device and activates the output unit.

12. The information processing apparatus according to claim 1, further comprising
a second sound collection unit that is provided adjacent to the output unit and that collects the measurement sound,
wherein the abnormality detection unit detects the abnormality based on an acoustic signal collected by the second sound collection unit.

13. The information processing apparatus according to claim 1,
wherein the information processing apparatus is a hearing aid.

14. The information processing apparatus according to claim 1,
wherein the information processing apparatus is an earphone.

15. An information processing system comprising:
an information processing apparatus capable of being at least partially attached to an ear canal of a user; and
a charger of the information processing apparatus,
wherein the information processing apparatus includes:
an output unit that outputs a measurement sound for detecting an abnormality of the information processing apparatus;
a first sound collection unit that collects the measurement sound; and
an abnormality detection unit that detects the abnormality based on an acoustic signal collected by the first sound collection unit.

16. The information processing system according to claim 15,
wherein the charger is configured as acoustically closed space capable of storing the information processing apparatus.

17. The information processing system according to claim 16, wherein the charger further includes a fixing portion that internally fixes the information processing apparatus.

18. The information processing system according to claim 16, wherein the charger further includes a third sound collection unit that collects the measurement sound.

19. The information processing system according to claim 15,
wherein the charger further includes an imaging unit that images the information processing apparatus that has been stored, and
the abnormality detection unit detects the abnormality based on an image captured by the imaging unit.

20. The information processing system according to claim 15, further comprising an information processing terminal capable of communicating with the information processing apparatus.

21. The information processing system according to claim 15, further comprising an information processing server capable of communicating with the information processing apparatus.

22. An information processing method of detecting an abnormality of an information processing apparatus capable of being at least partially attached to an ear canal of a user, comprising:
by the information processing apparatus,
outputting a measurement sound for detecting an abnormality of the information processing apparatus;
collecting the measurement sound; and
detecting the abnormality based on an acoustic signal that has been collected.
